(19) United States
(12) Patent Application Publication
(10) Pub. No.: US 2012/0191596 A1
(43) Pub. Date: Jul. 26, 2012

(54) EVALUATING, MONITORING, AND CONTROLLING FINANCIAL RISKS USING STABILITY SCORING OF INFORMATION RECEIVED FROM SOCIAL NETWORKS AND OTHER QUALIFIED ACCOUNTS

(76) Inventors: Gary Kremen, Menlo Park, CA (US); Eric King, (US)

(21) Appl. No.: 13/308,465

(22) Filed: Nov. 30, 2011

Related U.S. Application Data
(60) Provisional application No. 61/436,523, filed on Jan. 26, 2011.
(60) Provisional application No. 61/467,381, filed on Mar. 25, 2011.

(51) Int. Cl. G06Q 40/02

(52) U.S. Cl. 705/38

(57) ABSTRACT

A computer-implemented method for managing the financial risk in a risk-taking scenario associated with a subject of risk-taking. The method includes receiving authorization to access at least one qualified account of a subject of risk-taking; receiving data from the qualified accounts of the subject of risk-taking; determining a stability score based on the received data, the stability score being an estimate of the financial risk in the risk-taking scenario; and performing an action through the qualified account based on the stability score.

### CROSS REFERENCE TO RELATED APPLICATIONS

This application claims priority to U.S. provisional application Ser. No. 61/436,523, filed Jan. 26, 2011, entitled “Methods And Systems For Improving Timely Loan Repayment By Controlling Borrower Online Social Networking And Related Accounts,” and U.S. provisional application Ser. No. 61/467,381, filed Mar. 25, 2011, entitled “Methods and Systems For Improving Timely Loan Repayment By Controlling Online Accounts Or Notifying Social Contacts,” which are incorporated by reference herein.

### BACKGROUND

1. Technical Field

Various embodiments of this disclosure relate to systems and methods for performing quantitative and qualitative analysis of social networks to evaluate, monitor and control financial risks.

2. Description of Related Art

An important part of an economy is the ability of one party to take financial risks on behalf of another party in exchange for an expectation of a suitable risk-adjusted return on that investment.

A financial institution, such as a bank, may lend a sum of money (principal) to a borrower for a period of time under a loan agreement in which the borrower agrees to make periodic payments. The payments return the principal to the financial institution over time along with interest. The borrower generally intends to use the principal in a way that the borrower believes will return more value to the borrower than he or she has undertaken to pay the lender in interest. The interest is expected to compensate the financial institution for the time value of money, the relative risk that this particular borrower may not make all the loan payments as agreed, and the administrative costs of the loan.

Financial institutions generally evaluate the risk associated with a loan applicant by using information in the loan application and credit reports. Some loan applicants may be less susceptible to risk evaluation, such as those with limited work or credit history, or those that do not maintain bank accounts. What is needed are more effective methods of evaluating the risk associated with potential borrowers.

Financial institutions may periodically review a borrower's credit reports, but the credit reports may not be updated until long after the underlying events that caused or first indicated a change in associated risk. The financial institution's ability to respond to the change in circumstances may be more limited because of the delay. What is needed is a more timely and effective method of monitoring and controlling the risk associated with existing borrowers.

### BRIEF SUMMARY

The following detailed description discloses a computer-implemented method for managing the financial risk in a risk-taking scenario associated with a subject of risk-taking. The risk-taking scenario may include a loan or insurance, for example. The method includes receiving authorization to access at least one qualified account of a subject of risk-taking. These qualified accounts may include accounts at social network providers, email service providers, phone service providers, messaging service providers, gaming service providers, and online forum providers, for example. The method includes the step of receiving data from the qualified accounts of the subject of risk-taking. This data may include some or all the information accessible at these qualified accounts. The method further includes determining a stability score based on the received data. The stability score is an estimate of the financial risk in the risk-taking scenario. The method further includes performing an action through the qualified account based on the stability score.

### BRIEF DESCRIPTION OF THE DRAWINGS

FIG. 1 illustrates an embodiment of a system including a stability server that is configured to communicate with qualified account providers and information providers.

FIG. 2 shows an embodiment of a system including a stability server configured to control a proxy server to manage access to qualified account providers and information providers.

FIG. 3 is a logical representation of a stability server.

FIG. 4 is a flowchart of one embodiment of a loan evaluation process.

FIG. 5 is a flowchart of another embodiment of a loan evaluation process.

FIG. 6 is a flowchart of an embodiment of a process to determine whether to grant preferential terms in exchange for access to qualified accounts.

FIG. 7 is a flowchart of one embodiment of a process for evaluating, monitoring, and controlling financial risks using qualified account providers.

FIG. 8 is a flowchart of one embodiment of a process to control access to a qualified account by a subject of risk-taking.

FIG. 9 is one embodiment of a screen shot of a report indicating detected life events for subjects of risk-taking and recommended actions based on those detected life events.

FIG. 10 illustrates one embodiment of a machine configured to execute instructions to perform a method of the inventive subject matter.

### DETAILED DESCRIPTION

In the following detailed description, reference is made to the accompanying drawings that form a part hereof, and in which is shown by way of illustration, but not limitation, specific preferred embodiments in which the inventive subject matter may be practiced. These embodiments are described in sufficient detail to enable one of ordinary skill in the art to understand and implement them. It is to be understood that other embodiments may be utilized and that structural, logical, procedural and other changes may be made without departing from the spirit and scope of the inventive subject matter. Such embodiments of the inventive subject matter may be referred to, individually or collectively, by the term “invention” merely for convenience and without intending to voluntarily limit the scope of this application to any single invention or inventive concept if more than one is in fact disclosed. Therefore, the following detailed description is not to be taken in a limiting sense and the scope of the inventive subject matter disclosed herein is defined only by the claims and the equivalents thereof.

Some embodiments of the inventive subject matter are directed towards lending by financial institutions. When people need money, they often obtain the funds by applying for a loan from a financial institution, such as a bank or credit union. The financial institution generally makes an evaluation of a loan applicant based on information in the loan application and credit reports, which may include information about employment and prior credit use at other financial institutions. In some cases, the financial institution has a prior relationship with the applicant, which may include checking and savings accounts, credit cards and previous or existing loans.

Financial institutions evaluate information about the applicant to determine whether it makes financial sense to loan the money to the applicant and, if so, under what terms, including interest rate. In making these decisions, lenders often consider factors that are known as the “5 C's” of credit—collateral (assets to secure a loan), character (reputation, integrity or desire to repay the loan), capacity (sufficient cash flow to service the loan), capital (net worth), and conditions (of the borrower and the economy). The lender generally expects that the more or better the collateral, character, capacity, capital, and conditions, the more likely the applicant would repay the loan as agreed.

Some applicants may have an extensive positive history at the bank, an excellent credit report showing positive history at other financial institutions, a long work history at a stable employer, and significant income and net worth. However, the financial institution may have more limited and less definitive information to support the loan applications for other applicants. A young applicant may have little or no financial or employment history and may have relatively limited income and net worth even though they may have the wherewithal to repay a loan. Some would-be applicants may have little or no access to mainstream financial institutions (these people are sometimes referred to the “unbanked” and “underbanked”) and often rely on alternative resources such as check cashers, payday lenders, pawn brokers, and loan sharks. The unbanked and underbanked are unlikely to develop much of a financial history on credit reports, and may have relatively limited income and net worth even though they may have the wherewithal to repay a loan. Furthermore, some applicants may not be able to obtain a credit card and may want to borrow relatively small amounts of money or borrow the money for relatively short periods of time. A financial institution may not consider loans for smaller amounts or for shorter periods because their overhead in evaluating and servicing such loans is too large relative to the income from such loans.

Embodiments of the inventive subject matter include systems and methods for a financial institution to receive access to one or more qualified accounts of the applicant for the term of the loan. Qualified accounts are those that provide access to information that is used either alone or in combination with other qualified accounts and information sources according to the inventive subject matter. For example, qualified accounts may be accounts for social networks, email and text messaging services, and online forums. The financial institution may require that the applicant provide access to one or more qualified accounts during evaluation of the application and, if approved, during the term of the loan. In other cases, the financial institution may offer preferential terms, such as a better interest rate, if the borrower provides ongoing access to their qualified accounts.

In some embodiments of the inventive subject matter, the financial institution (or a service provider acting on behalf of the financial institution) accesses the social networks and other qualified accounts to evaluate, monitor and control the risk of a loan to an applicant.

In some embodiments of the inventive subject matter, the financial institution (or a service provider acting on behalf of the financial institution) access the qualified accounts to evaluate the loan application. The grant of access in and of itself may be a positive signal to the financial institution about the applicant because it may be an indication that they do not have anything to hide. The information provided in the loan application may be checked for consistency with the information retrieved from the applicant's qualified accounts. For example, the system might determine that the city of residence reported in the loan application is the same as the city of residence reported in the qualified accounts and consistent with the location of the applicant's computer based on its internet protocol (IP) address. Inconsistencies might lead to follow up questions for resolution, or might result in rejection of the loan application.

In some embodiments, the qualified accounts are evaluated to determine whether access to the qualified accounts would be useful enough according to the inventive subject matter. For example, the applicant's social network may have few “connections,” sometimes referred to as “contacts” or “friends,” or very little activity such that it may not be the applicant's primary account or the applicant may not use social networks to a sufficient degree to provide enough information for use according to the inventive subject matter. In such a case, the financial institution may not be willing to approve the loan or offer preferential terms in exchange for such limited information. In fact, the applicant may be withholding their more active, primary social networks and other qualified accounts and may have even have created the offered qualified accounts as an alternative to granting access to their primary qualified accounts.

Some embodiments may use information from the loan application and other qualified accounts to assess the applicant's susceptibility to techniques to control, influence and assist the applicant in meeting the terms of the loan until the loan is paid as agreed according to the inventive subject matter. Some embodiments may include a psychological assessment based on the received information.

The financial institution uses the information from the qualified accounts to more accurately assess the risk associated with the loan. In some embodiments, the financial institution can use the assessment to set an interest rate and other loan terms that are more likely to provide a suitable risk-adjusted return and are less likely to be undercut by financial institutions competing for the loan.

Without the information from the qualified accounts, the financial institution may be more likely to overestimate the associated risk and therefore overestimate the interest rate required to achieve a suitable risk-adjusted return. In some cases, the financial institution may lose a profitable loan to a financial institution that more accurately assesses the risk. In other cases, they may decide they cannot offer that loan because the estimated interest rate would violate usury laws whereas a more accurately estimated interest rate would not.

Without the information from the qualified accounts, the financial institution might underestimate the associated risk and underestimate the interest rate required to achieve a suitable risk-adjusted return. In such a case, the financial institution may accept a loan at an interest rate that does not sufficiently cover the average default and collection costs of those with the actual level of risk associated with the loan applicant. On average, the return of such loans will not provide a suitable risk-adjusted return.

In some embodiments, the financial institution might agree to make a loan that they would not have made if the applicant had not granted access to their qualified accounts. In other cases, the financial institution might offer a better interest rate or other improved loan terms in exchange for a grant of access to such information by the applicant. In some embodiments, ongoing access to the information from the qualified accounts allows the financial institution to monitor, evaluate and control the associated risk on an ongoing basis thereby reducing the risk of the loan. As a result, there may be a lower expected default and collection cost associated with an applicant that provides access to qualified accounts as compared to an identical applicant that does not provide access to qualified accounts.

Many of the advantages of access to qualified accounts are realizable regardless of why the applicant grants access to the qualified account information. Furthermore, the financial institution may be able to access information made public on the social network or other qualified accounts to use according to the inventive subject matter without a grant of access by the applicant.

Some embodiments of the inventive subject matter use access to qualified accounts to detect or predict events and issues that may affect loan performance. For example, events and issues might include problems at work including loss of a job, divorce or other relationship problems, health or legal problems, and relocation. Some embodiments of the inventive subject matter provide earlier detection or prediction of potential loan performance problems and enables the financial institution to act promptly and effectively according to the detected or predicted events and issues.

Some embodiments of the inventive subject matter enable a financial institution to better control, influence or assist the borrower in complying with the loan terms. The financial institution may use ongoing access to the qualified accounts to take action in certain ways that are available to the financial institution by virtue of the access to the qualified accounts. In some embodiments, the borrower has granted permissions to perform these types of actions in the qualified account using a protocol, such as OATH 2.0, as part of the process of granting access to the financial institution. Furthermore, the applicant may consent to a specific potential actions under the terms of the loan agreement.

Actions may include using the social network or other qualified accounts to contact the borrower to inquire about a detected event or issue, such as a job loss or relocation. Actions may also include sending an electronic message or making a posting on the qualified account that is viewable by one or more of the borrower's personal contacts. This might include posting a notice that the borrower is behind on his payments. When the posting is viewable by at least one of the borrower's contacts, posting might encourage the borrower to make the payments more effectively than a private message would. Furthermore, one or more of the borrower's personal contacts may be willing and able to help the borrower and, but for the posting by the financial institution, might not have otherwise known about the problem. Some of these personal contacts may help the borrower meet their loan obligations or resolve the underlying issues that may potentially compromise loan performance or are compromising loan performance. Actions may include prompting a friend of the borrower to coach the borrower through the event or issue in order to reduce the impact on loan performance. This friend may have agreed to act as a loan coach on behalf of the borrower as part of the loan application process. Actions may include denying or limiting access to one or more of the qualified accounts in response to a default or other breach of the loan agreement. For example, the financial institution may prevent the borrower from logging into their social network account until the borrower brings the delinquent loan current. In other embodiments, the financial institution allows the borrower to log into the social network, but prevents the borrower from accessing certain information, such as photos, or performing certain actions, such as playing games, until the until the borrower brings the delinquent loan current.

Some borrowers may be asked to pay a higher interest rate not because they are necessarily higher risk but because there is more uncertainty or inaccuracy in evaluating their risk. That is, with more information, financial institutions may be better able to distinguish the risk-characteristics of certain borrowers so that they are classified into risk categories that better represents the expected cost of default or collections for that borrower.

The ability to evaluate, monitor and control risks may allow financial institutions to more accurately price loans and faster, more automated response to events and issues may allow financial institutions to more cost-effectively service loans at any given risk level. This improvement may allow a particular financial institution to be better able to secure loan opportunities relative to competing financial institutions. Better pricing efficiency may also allow loans to be approved which may not have otherwise been made. For example, risk and uncertainty may be mitigated by the use of techniques to better evaluate, monitor and control financial risks. This may not only result in improved financial returns at the financial institution, but improved benefits to the economy overall.

Some embodiments of the inventive subject matter may be applied to other risk-taking scenarios, such as insurance policies. For example, the risk-taking entity may be a financial, institution that provides health, life, auto, home or professional liability insurance. The financial institution may access the qualified accounts to check for consistency and supplement the information provided in the insurance policy application. The terms of the insurance policy may require that the applicant provide ongoing access to qualified accounts for the term of their insurance policy. In other cases, the policy might be offered with preferential terms, such as a lower insurance premium, if the applicant provides ongoing access to their qualified accounts.

Some embodiments of the inventive subject matter may use the qualified accounts to detect and predict events and issues that may impact the performance of the insurance policy. For example, the subject of the risk-taking (the insured) may engage in risky behavior not permitted under the terms of the policy. For example, embodiments of the inventive subject matter may determine that the insured is smoking cigarettes by monitoring communications in a qualified account. If their health insurance policy indicates they are a non-smoker, an email might be sent to the insured to ask that they stop smoking or that they update their policy to a smoking policy and pay the increased premiums. In some embodiments, the insurance company sends information about resources and methods to quit smoking through the social network, such as an email or posting on the wall of a social network, in some cases providing the methods and resources that the insured uses to quit smoking. In some embodiments, the insurance company may send a posting to the qualified account stating that the insured should quit smoking for a healthier lifestyle and remain compliant with the terms of their insurance policy. In some embodiments, the insurance company may post this information such that it is viewable by at least one of the contacts of the insured and that may prompts at least one of the personal contacts to help the insured quit smoking. In other cases, if the detected non-compliance is particularly egregious or repeated, the financial institution may cancel the policy. In some embodiments, the detected event or issue is not a violation of the insurance policy terms, but the insurance company sends a message to influence or assist the insured in reducing the insured's risk and the insurance company's expected cost. This may be in the best interest of the insured and the insurance company.

Some embodiments of the inventive subject matter may be applied to micro-lending scenarios. For example, the risk-taking entity may be an individual that lends money through a micro-lending organization. One example of a micro-lending organization is Kiva Microfunds of San Francisco, Calif. Kiva Microfunds connects lenders with borrowers through their website at Kiva.com. Embodiments of the inventive subject matter permit the subjects of the risk taking to be evaluated and monitored with relatively little overhead. Furthermore, embodiments of the inventive subject matter permit the risk-taking entities to more cost-effectively control, influence and assist the lender in meeting their loan obligations. Given the relatively small amounts of micro-loans, the amount of interest received may be relatively small and therefore cannot support much loan-origination and loan-servicing costs.

In some embodiments, the risk-taking entity may be one or more otherwise unassociated individuals that independently agree to loan money to the subject of the risk-taking. In yet other embodiments, the risk-taking entity may be a non-profit organization. The inventive subject matter may be applied to other types of risk-taking entities. The risk-taking entity may be motivated by either return-on-investment or philanthropy, or some combination of both. But many that are primarily interested in making a positive impact recognize that if a loan is paid back, that money may be reinvested to do more good. And if a reasonable return-on-investment is realized, more people will be interested in making such loans. Therefore, profitable lending is likely to produce more good in the long term.

In some embodiments, the subject(s) of risk-taking are one or more individuals, a family, or representatives of a small, medium or large business.

Embodiments of the inventive subject matter may be applied to other risk-taking scenarios besides lending money or insuring the subject(s) of risk. These risk-taking scenarios may involve the risk-taking entity taking an asset that is equity-based, debt-based, based in some combination of debt and equity, or some more complex financial instruments in exchange for providing funds or other assets to the subject(s) or risk-taking. The inventive subject matter may be applied to the subject(s) of the risk-taking to detect and predict events that may impact valuation and performance of the asset(s) received by the risk-taking entity. The inventive subject matter may be applied to the subject(s) of the risk-taking to control, influence or assist the subject(s) of the risk-taking to positively impact valuation and performance of the asset(s) received by the risk-taking entity.

In some cases, the subject of the risk-taking may be taking risk in the risk-taking entity. For example, the subject of risk-taking may receive an asset other than cash that is equity-based, debt-based, based in some combination of debt and equity, or some more complex financial instrument. Thus, the first party is a risk-taking entity with respect to the asset provided to the second party and the second party is a risk-taking entity with respect to the asset provided to the first party. Each party is a subject of risk-taking for the corresponding asset. Thus, the inventive subject matter may be applied to both parties as risk-taking entities and as subjects of risk-taking in the same transaction.

In some embodiments, the risk-taking entity is taking some form of financial risk and uses the inventive subject matter to monitor or reduce that risk. However, embodiments of the inventive subject matter may be applied where a risk-monitoring entity has a non-financial stake in the subject of risk-monitoring, and the inventive subject matter is used to reduce the risk. For example, a parent may use the inventive subject matter to monitor the qualified accounts of their child and promptly take action when relevant events or issues are detected or predicted.

In some cases, the inventive subject matter is applied by the risk-taking entity itself. In other cases, the inventive subject matter is provided by a third-party to the risk-taking scenario acting on behalf of the risk-taking entity.

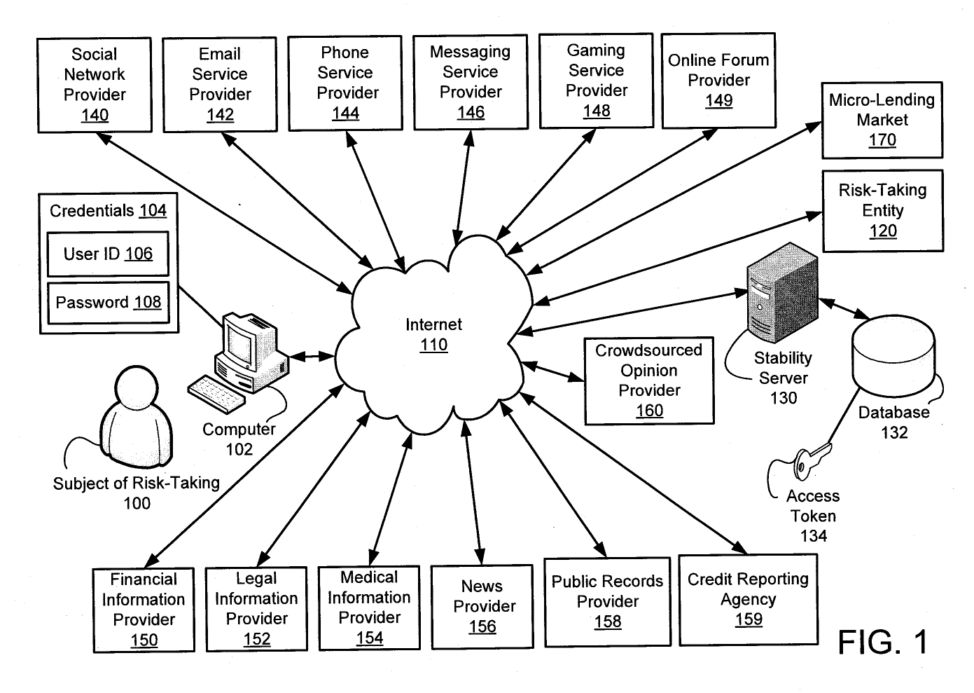

FIG. 1 illustrates an embodiment of a system of the inventive subject matter. This system is described with reference to lending, micro-lending and insurance scenarios, but the inventive subject matter could be applied to other risk-taking and risk-monitoring scenarios.

In some embodiments, a subject of risk-taking 100 is an individual applying for a loan. In other embodiments, the subject of risk-taking 100 is an individual applying for health, life, auto, home or professional-liability insurance. In other embodiments, a risk-taking scenario may include two or more subjects of risk-taking, such as two or more people representing themselves or representing a business entity. Examples of such scenarios may include a husband and wife applying for a home mortgage and business partners applying for a business loan.

In some embodiments, the subject of risk-taking 100 applies for a loan or insurance using a computer 102 connected to the internet 110. The subject of risk-taking 100 may connect with the website of a risk-taking entity 120 via the internet 110 to submit an application. The subject of risk-taking 100 may connect via the internet 110 to a micro-lending market 170 to submit an application. Applications submitted to the micro-lending market 170 are considered by the risk-taking entity 120 and the other risk-taking entities that participate in the micro-lending market 170. In other embodiments, the subject of risk-taking 100 submits an application on paper by mail or in a branch office and that information is converted to electronic form for subsequent processing.

In some embodiments, the subject of risk-taking 100 uses the computer 102 to connect to the qualified account provider via the internet 110 and submits their authentication credentials to establish their identity as the owner of the qualified account. The subject of risk-taking 100 may present their authentication credentials by entering a user id 106 and a password 108 using the keyboard of the computer 102. Other methods of authenticating the identity of the qualified account holder may be used. Something the owner of the qualified account possesses may be used to confirm the identity of the person being authenticated. For example, as part of the authentication process, the qualified account provider may automatically send a text message to the pre-specified cell phone of the qualified account owner. This text message might provide a code that must be submitted by the person being authenticated. Biometric analysis, such as voice recognition, fingerprint matching, or retina scan, may be used to confirm the identity of the person being authenticated by matching biometric data collected at the computer 102 with previously collected biometric data of the qualified account owner. In some cases, multiple methods may be used. For example, the authentication process may require the person being authenticated provide something the owner of the qualified account knows (e.g., a password), something the owner of the qualified account has (e.g., cell phone attached to the pre-specified cell phone number of the qualified account owner) and something the owner of the qualified account “is” (e.g., retina scan).

Once authenticated, the subject of risk-taking 100 grants access to some or all of the information in the qualified account to a stability server 130. The stability server 130 may be operated by the risk-taking entity 120 or the micro-lending market 170, for example, or operated by a third-party acting on behalf of one or more risk-taking entities or intermediaries such as the micro-lending market 170. The stability server 130 may store information related to the subject of risk-taking 100 in a local database 132. The local database 132 may be used to store information provided in the loan or insurance application, credentials to access one or more qualified accounts of the subject of the risk taking 100, and credentials to access one or more qualified information providers.

The risk-taking entity 120 may be a party to one or more risk-taking scenarios. In some embodiments, the risk-taking entity 120 is a financial institution, such as a bank or insurance company. The risk-taking entity 120 considers a loan or insurance application from the subject of risk-taking 100, and, if approved, services the approved loan or insurance policy for the subject of risk-taking 100. In some embodiments, the risk-taking entity 120 may receive loan or insurance applications through the financial institution's website connected to the internet 110 or via other electronic means. In some embodiments, applications may be received on paper and converted to electronic form.

In some embodiments, the risk-taking entity 120 is an individual that visits a micro-lending market 170 via the internet 110. The micro-lending market 170 may include loan applications submitted by the subject of risk-taking 100. The subject of risk-taking 100 may use the computer 102 to connect to the micro-lending market through the internet 110 and create an account on the micro-lending market 170 that describes their risk-taking scenario. For example, the subject of risk-taking 100 may identify themselves and their financial history, how much money they want to borrow, how they expect to use those funds, and how they expect to make the loan payments.

In some embodiment, the subject of risk-taking 100 may submit information typically submitted in a traditional loan application, but supplement that information with access to qualified accounts according to the inventive subject matter. In other embodiments, the subject of risk-taking 100 submits a loan application that includes little or no information in the form of a traditional loan application and relies more heavily or exclusively on providing access to qualified accounts according to the inventive subject matter.

The risk-taking entity 120 may review the loan application of the subject of risk-taking 100 via the micro-lending market 170 and decide to provide some or all of the funds requested in the loan application. In some cases, other risk-taking entities review risk-taking scenarios in the online micro-lending market 170 and independently choose to provide some or all of the requested funds for the subject of risk-taking 100. Thus, several risk-taking entities may independently provide portions of the requested funds for the subject of risk-taking 100.

There are many types of qualified account providers. Qualified account providers may be associated with a social network provider 140, an email service provider 142, a phone service provider 144, a messaging service provider 146, a gaming service provider 148 or an online forum provider 149. In some embodiments, a single qualified account provides access to information that may be used alone, or in combination with other information sources, according to the inventive subject matter. In other embodiments, two or more qualified accounts are used, alone or in combination with other information sources, according to the inventive subject matter. These types of qualified account providers are meant to illustrate how exemplary types of qualified account providers may be used according to the inventive subject matter. Some qualified account providers may have characteristics of more than one type of provider illustrated here. Other qualified account providers may not fit in any of the illustrated types of qualified account providers.

One or more qualified accounts may be associated with social network providers. In some embodiments, the social network provider 140 provides a platform for individuals and organizations to connect with each other and share information. Connections are frequently based on kinship, friendship, mutual interests such as business or sexual interests, common interests such as shared political, religious, civic or subject-matter interests, or shared status such as professional or alumni associations. In some embodiments, connections may be based on any reason or no reason, as long as one party requests the other party connect with them and the other party accepts that request. In other embodiments, one party may subscribe to the qualified account of the other such that information flow is primarily or exclusively in one direction between the parties. For example, a member of the public may subscribe to information published by an organization or public figure because they are interested in information about that organization or public figure. In some embodiments, the social network provider 140 is Facebook®, LinkedIn®, Twitter®, Myspace®, Ning®, Google+™, Bebo®, Classmates.com®, Plaxo®, Orkut®, Flickr®, Match.com™ or the like.

The scope of access granted to a qualified account at a social network provider 140 may include information such as names, employer and employment history, education, addresses and other contact information, interests, status, activities, events, contacts, relationships between contacts, and communications between and among contacts. Many people use social networks to share information about their life with their family, friends, colleagues and acquaintances.

One or more qualified accounts may be associated with email service providers. In some embodiments, the email service provider provides a platform for sending and receiving e-mail messages. The email service provider 142 may provide services such as Microsoft® Hotmail®, Yahoo® Mail, Google® Gmail®, or AOL® Mail. The scope of access granted to the qualified account at the email service provider 142 may include, for example, messages that have been sent or received, contact databases including names, phone numbers, email addresses and mailing addresses, and calendar information such as meetings and events.

One or more qualified accounts may be associated with phone service providers. In some embodiments, the phone service provider 144 provides wireless phone services, traditional landline phone services, voice-over-internet-protocol (VoIP) based phone services, or services based on other technologies that enable remote communications using voice. In some embodiments, the phone service provider 144 may be Verizon®, AT&T®, Sprint®, Skype®, Vonage®, or Google Chat™. The scope of access granted to a qualified account at the phone service provider 144 may include, for example, phone conversations, messages and contact databases including names, phone numbers and email addresses.

One or more qualified accounts may be associated with messaging service providers. In some embodiments, the messaging service provider 146 provides text-based communications over networks. The messaging service provider 146 may offer text messaging services via Short Messaging Service (SMS) or text-based chat services over internet connections, for example. The messaging service provider 146 may be Verizon, AT&T wireless, Sprint, Skype, Yahoo Messenger, Windows Live Messenger, Google Chat, AOL Instant Messenger, or Tencent QQ, for example. The scope of access to a qualified account at the messaging service provider 146 may include, for example, messages, contact databases including names, phone numbers and email addresses.

One or more qualified accounts may be associated with gaming service providers. In some embodiments, the gaming service provider 148 provides multiplayer games, simulation environments, or gambling such as poker and blackjack. In some embodiments, the gaming service provider 148 may be Zynga®, Playdom®, Linden Lab®, Blizzard Entertainment® or Gaia Interactive®. The scope of access granted to a qualified account at the gaming service provider 148 may include, for example, contact information of fellow players, discussion of real life events and issues with fellow players, and financial events such as gambling losses.

One or more qualified accounts may be associated with online forum providers. In some embodiments, the online forum provider 149 may include product and company review sites, food and eating sharing sites, health and medical information sharing sites, special interest groups, or other online sites that provide for discussion among people and organizations that visit the site. In some embodiments, the online forum provider 148 is CNET®, Epinions®, Epicurious®, or WebMD™. The scope of access granted to a qualified account at the online forum provider 149 may include, for example, contact information of fellow forum members, transaction information indicating the purchase of risky products or books about health issues or risky activities, discussion of risky products that the subject of risk-taking 100 uses, risky activities that the subject of risk-taking 100 engages in, the diet of the subject of risk-taking 100, or health concerns of the subject of risk-taking 100.

In some embodiments, various qualified account providers may be classified in more than one of the aforementioned categories because, for example, they offer several services, each falling under different categories, or because they offer a service that has characteristics of more than one category. For example, Twitter is often characterized as a social network in that it sends messages to a list of subscribed contacts that are part of the sender's social network. However, Twitter uses SMS messaging to communicate with those users and therefore may also be classified as a messaging services provider. These categories of qualified account providers are used to illustrate how exemplary types of qualified accounts may be used according to the inventive subject matter. The aforementioned categories are not meant to be exhaustive. Qualified accounts may be used according to spirit and scope of the inventive subject matter even if they do not fit into any of these exemplary categories.

Embodiments of the inventive subject matter may include providing disclosures to the subject of risk-taking 100 as to how the risk-taking entity may use access to the qualified accounts so that informed consent is obtained from the subject of risk-taking 100. In some embodiments, filters and restrictions may be applied to information accessed and shared in order to be compliant with consumer-protection laws, privacy laws and other laws and regulations with respect to the information gathered and used and action taken in response to that information.

The inventive subject matter is not limited to particular ways to provide access to the information in the qualified accounts. In some embodiments, protocols, codes, software or other electronic mechanisms are used to authenticate and grant access. Examples of authentication identification could include uniform resource locators (URLs) and extensible resource identifier (XRIs) for OpenID®, extensible markup language (XML), security assertion markup language (SAML), protocols for JanRain®, and tokens for open authorization (OAuth). An example of a security authentication provider is an OpenID provider. Examples of authentication service providers include Google, Inc., AOL®, Myspace, MyOpenID, Facebook Connect®, and Verisign®.

In some embodiments, the subject of risk-taking 100 provides access to the risk-taking entity 120 or the micro-lending market 170 by providing the credentials 104 to the stability server 130 so that the stability server 130 may independently log into the qualified account as long as the subject of risk-taking 100 does not change the credentials 104.

In some embodiments, the subject of risk-taking 100 delegates email access to an email account controlled by the stability server 130. In some embodiments, access is delegated to the stability-server 130 using a mechanism such as Microsoft Exchange delegation or Gmail delegation.

In some embodiments, the subject of risk-taking 100 may install software on their computer 102, phone, or other device such that some or all information sent between the device and the qualified account is forwarded to the stability server 130 by the software.

In some embodiments, the subject of risk-taking 100 logs into the qualified account provider using the credentials 104 and then grants access to their qualified account to an application hosted by the stability server 130. For example, Facebook uses OAuth 2.0 protocol for authentication and authorization of Facebook applications. The Facebook application hosted by the stability server 130 may be configured to request read access, write access, or both read and write access to aspects of the Facebook account of the subject of risk-taking 100. The subject of risk-taking 100 approves this access as a condition of the loan or insurance policy. The access granted includes access to aspects of the social network as defined by the granularity of permissions for the Facebook social network. Once authorized the social network 140 provides an access token 134 to the stability server 130 via the interne 110. The stability server 130 stores the access token 134 in a local database 132 to provide to the social network 140 as an authentication mechanism when the stability server 130 subsequently requests access to the social network 140 to access information from that qualified account.

Each qualified account may include information that alone, or in combination with information from other qualified accounts or other information sources, helps detect or predict events or issues that may affect performance of a loan or insurance policy, or some other risk-taking scenario. Communications between the subject of risk-taking 100 and his or her family, friends and colleagues through the qualified accounts may be a significant, timely and credible source of relevant information to use according to the inventive subject matter.

Some qualified accounts may include contact information for family, friends and colleagues of the subject of risk-taking 100. Since this contact information comes directly from the contact databases that the subject of risk-taking 100 is using to contact these people, it is likely to be accurate and current. Traditional sources of contact information of family and friends, such as the references listed in loan applications, are generally limited to one or two contacts, and may not be current when they need to be used. Furthermore, since many qualified accounts may have contact information, these sources may be combined to some extent to provide alternative and redundant means of contacting various people (e.g., phone numbers, email addresses, and mailing address) to reduce the likelihood that any particular contact is unreachable because of inaccurate or stale data. Accessible information about these contacts may help prioritize which contacts to engage. For example, close family or friends may generally be more useful to track down a delinquent borrower and more likely to influence or assist the borrower in bringing the account current. However, posting a past-due notice that is viewable by an acquaintance (or threatening to do so) may be more effective in motivating the borrower to bring the account current than to do so with respect to close family or friends because family and friends are more likely to already know about the situation. In some embodiments, the subject and frequency of communications between the subject of risk-taking 100 and each contact is used in part as an indicator as to how close the contact is to the subject of risk-taking 100.

In some embodiments, qualified accounts may be acted upon by the stability server 130 to control, influence, or assist the subject or risk-taking 100. For example, the stability server 130 might post a past-due notice on the “wall” of a Facebook account such that it is viewable by one or more contacts of the subject of risk-taking 100. Embarrassment about the posting may more effectively motivate the subject of risk-taking to bring their loan current than a private message would. Family or friends who might otherwise not have known about the past-due status, may be able and willing to help the subject of risk-taking make the payments to bring the account current. In another example, the stability server 130 might send information about resources and techniques to quit smoking when a subject of risk-taking 100 shows signs of picking up the habit in violation of the terms of their insurance policy. The message might also note the increased premiums that would be due if the insured were required to change to a smoking policy. This might provide the motivation, information and resources that will help the subject of risk-taking 100 lead a healthier life and comply with the terms of their insurance policy. It also may reduce the likelihood that the insured can cheat on their insurance policy and thereby saddle the insurance company with a greater risk (and greater expected costs) than they agreed to assume.

In some embodiments, the stability server 130 may gather information from information providers to supplement the data made available through the qualified account providers. The information providers may include a financial information provider 150, a legal information provider 152, a medical information provider 154, a news provider 156, a public records provider 158, a credit reporting agency 159 and a crowdsourced-opinion provider 160.

Some information providers may provide some or all of the information for free. Some information providers may charge fees based on, for example, a monthly subscription rate, the quantity of information retrieved, or the connection time. Some information providers may require an account to access some or all the information. In some embodiments, accounts may be established, and fees paid, by the operator of the stability server 130.

One or more information providers may provide access to financial information. In some embodiments, the financial information provider 150 may be Yahoo Finance, Google Finance, Hoovers®, or the Security and Exchange Commission. Financial information may be used, for example, to evaluate the financial position of a new or existing employer of the subject of risk-taking 100 or the financial position of the primary customers of the subject of risk-taking 100.

One or more information providers may provide legal information. In some embodiments, the legal information provider 152 may be LexisNexis®, Westlaw® CourtExpress, Public Access to Court Electronic Records (Pacer), or a federal or state court website. Legal information may be used, for example, to detect and evaluate the status of a lawsuit in which the subject of risk-taking 100 or the employer of the subject of risk-taking 100 is a party.

One or more information providers may provide medical information. In some embodiments, the medical information provider 154 may be Medline Plus. Medical information may be used, for example, to evaluate the implications of health related events and issues of the subject of risk-taking 100 and those he or she depends on or is responsible for.

One or more information providers may provide news. In some embodiments, the news provider 156 may be Google News, the New York Times, the Wall Street Journal and the Economist. News may be used, for example, to identify events that may impact performance of the loan or insurance policy of the subject of risk-taking 100. For example, some news may be related to general economic conditions, economic conditions in the industry in which the subject of risk-taking 100 works, or economic conditions in the city of the subject of the risk-taking.

One or more information providers may provide public records. In some embodiments, the public records provider 158 may be state or local government agencies such as the office of a secretary of state or county recorder. Public records may be used, for example, to evaluate the implications of recorded events with regard to performance of the loan or insurance policy of the subject of risk-taking 100. For example, the public records may indicate that the subject of risk-taking 100 lost title to their home, or had a lien filed against them.

One or more information providers may be a credit reporting agency databases. In some embodiments, the credit reporting agency 159 may be Equifax®, TransUnion®, or Experian®. This information may be used, for example, to evaluate the credit worthiness of the subject of risk-taking 100 and to discover events that may indicate changes in credit worthiness during performance of the loan or insurance policy.

One or more information providers may be crowdsourced-opinion providers. In some embodiments, the crowdsourced-opinion provider 160 may be used to evaluate information about the subject of the risk-taking. For example, the stability server 130 may submit some information about the subject of risk-taking 100 to receive an aggregate opinion from many unassociated people. In some embodiments, these opinions may indicate a recommended course of actions or be used to by the stability server 130 to select a course of action among several options. In some embodiments, identifying information is removed before providing to the crowdsourced opinion provider so that the unassociated people base their opinions on anonymous information.

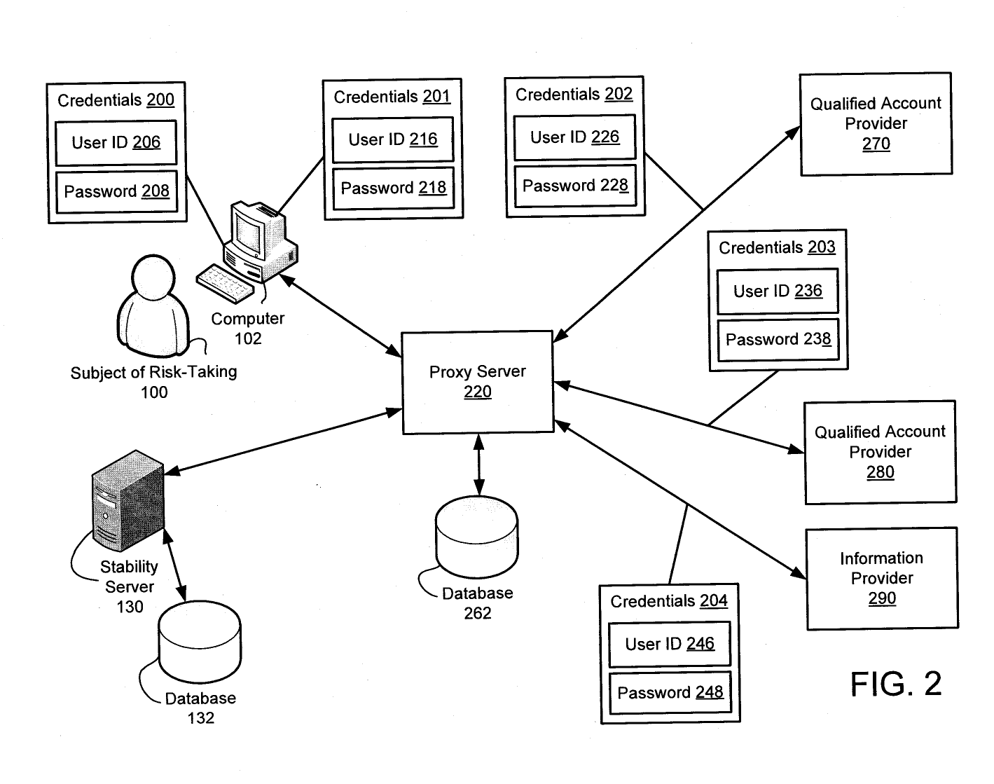

FIG. 2 illustrates an embodiment of a system of the inventive subject matter using a proxy server 220.

In some embodiments, the proxy server 220 may be used to secure access and control of qualified accounts at one or more qualified account providers during the period of risk-taking. In some embodiments, the period of risk-taking 100 may start when the principal is loaned to the subject of risk-taking 100 and end when the loan is paid-in-full. In other embodiments, the period of risk-taking 100 may be the period in which the subject of risk-taking 100 is insured under a home, auto, health, life or professional liability insurance policy. In some embodiments, the qualified account provider 270 and the qualified account provider 280 may each be one of the social network provider 140, the email service provider 142, the phone service provider 144, the messaging service provider 146, the gaming provider 148 or the online forum provider 149.

In some embodiments, the proxy server 220 may be used to manage credentials for accounts at one or more information providers used by the stability server 130. In some embodiments, the information provider 290 may be the financial information provider 150, the legal information provider 152, the medical information provider 154, the news provider 156, the public records provider 158, the online forum provider 159 or the crowdsourced opinion provider 160.

The proxy server 220 may prevent the subject of risk-taking 100 from changing their password to revoke access or control that had been granted as a condition of the loan or insurance policy. In addition, the proxy server 220 may allow for a larger scope of access than could be enabled through alternative mechanisms to grant access to the stability server 130. For example, a qualified account provider may not allow access tokens to have certain access permissions, or have the desired granularity of access permissions, and these limitations may compromise the systems or methods of the inventive subject matter. With full account access, the proxy server 220 may be used to limit or filter the received information from the qualified account at the qualified account provider in a way that is custom tailored to the access terms of the loan or insurance policy.

In some embodiments, the subject of risk-taking 100 may use the computer 102 to log into their qualified account at a qualified account provider 270 directly through the internet 110. However, in other embodiments, the risk-taking entity 120 requires the subject of risk-taking 100 to access their qualified account at the qualified account provider 270 by logging in through a proxy server 220 that is under the control of the stability server 130.

In some embodiments, the subject of risk-taking 100 enters their credentials 200 for the qualified account at the qualified account provider 270 through the proxy server 220. The credentials 200 may include a user id 206 and a password 208. The proxy server 220 uses credentials 202 including a user id 226 and a password 228 to log into the qualified account at the qualified account provider 270. Initially, the proxy server 220 sets credentials 202 to be the same as the credentials 200 so that the proxy server 220 obtains access to the qualified account at the qualified account provider 270. The proxy server 220 then uses access to the qualified account to change the password for the qualified account at the qualified account provider 270 so that password 228 is different from password 208. Credentials 200 and credentials 202, the relationship between credentials 200 and credentials 202 and the relationship to the qualified account 270 are stored in a database 262 for subsequent use by the proxy server 220.

After the password is changed, the subject of risk-taking 100 cannot log into the qualified account directly at the qualified account provider 270 because password 202 is no longer recognized by the qualified account provider 270 as the correct password and the subject of risk-taking 100 does not know the password 228. The subject of risk-taking must use the proxy server 220 to access their qualified account at the qualified account provider 270. When the subject of risk-taking 100 logs in through the proxy server 220 using credentials, the proxy server confirms that the entered credentials match the credentials 200 stored in the database 262 as the credentials expected to be provided by the subject of risk-taking 100. If the entered credentials do not match credentials 200, the proxy server 220 rejects the login attempt. If the entered credentials match credentials 200, the proxy server 220 retrieves the substitute credentials for credentials 200 by using the relationship stored in the database 262. This relationship indicates that credentials 202 are the substitute credentials for credentials 200 when accessing qualified account provider 270. The proxy server 220 then supplies credentials 202 during the authentication process for the qualified account at the qualified account provider 270. Once logged in, the proxy 220 server acts as an intermediary in all communications between the subject of risk-taking 100 and the qualified account provider 270. As an intermediary, the proxy server 220 does not pass on requests by the subject of risk-taking 100 to change or reset the password or otherwise revoke control by the proxy server 220. In some embodiments, the user id 226 may be the same as user id 206. In other embodiments, the proxy server 220 changes the user id when it changes the password.

In other embodiments, the credentials 202 may include additional or alternate mechanisms for authenticating identity. For example, the credentials 200 may include various question-and-answer pairs about the subject of risk-taking 100 that may be used during the authentication process. For example, questions may be “what is your mother's maiden name?” or “what is the name of the hospital where you were born?”

The subject of risk-taking 100 may be required to submit all question-and-answer pairs to the proxy server 220 during the application process for the loan or insurance policy. In some embodiments, the proxy server 220 may pass on challenge questions generated by the qualified account provider 270 and monitor the answer provided by the subject of risk-taking 100 to collect the pairs of questions and answers. The proxy server 220 may save these answers in order to subsequently use one or more of these question-and-answer pairs if required to independently obtain access to the qualified account at the qualified account provider 270.

Question-and-answer pairs are sometimes used as an alternative authentication mechanism to login, recover a lost password, or reset the password. Question-and-answer pairs might be used by the subject of risk-taking 100 to regain direct access to their qualified account at the qualified account provider 270 after the password 228 was changed to be different from password 208. For example, in response to a request by the subject of risk-taking 100 to reset the password, the qualified account provider 270 may ask a question of the requester to see if the requester responds with the associated answer in the question-and-answer pair. If there is a match, the requester is allowed to set a new password. Since the subject of risk-taking 100 would then know the new password, they could directly log into the qualified account of the qualified account provider 270 thereby circumventing control by the proxy server 220. Since the stability server 130 would not have the new password, the stability server 130 would not be able to access the qualified account at the qualified account provider 270.

In some embodiments, the proxy server 220 may disable challenge questions, if possible for the qualified account at the qualified account provider 270 in order to prevent the subject of risk-taking 100 from circumventing control by the proxy server 220. In other embodiments, the proxy server 220 may change the answers to be different from the answers provided by the subject of risk-taking 100. In some cases, the substituted answer may be another plausible but different answer, such as a different maiden name or hospital name, and in other cases, the substituted answer may be a string of letters, numbers and symbols that have no meaning. The substituted answers may not in fact be true with respect to the subject of risk-taking 100 but is treated as a correct answer by the qualified account provider 270.

In some embodiments, question-and-answer pairs are used as part of the standard authentication process. If the proxy server 220 is acting as an intermediary between the subject of risk-taking 100 and the qualified account provider 270, the proxy server 220 passes the question from the qualified account provider 270 to the subject of risk-taking 100. If the subject of risk-taking 100 responds with the correct answer stored as part of credentials 200 in the database 262, the proxy server uses credentials 202 (the substituted credentials in that case) to supply the substituted answer to the qualified account provider 270. If the subject of risk-taking 100 answers these questions directly at the qualified account provider by entering correct answers (e.g., their mother's maiden name or the hospital where he or she was born), the qualified account provider will reject these answers because it expects the substituted answers which the subject of risk-taking 100 does not know.

In some embodiments, passwords may be reset at the qualified account provider 270 upon request as long as a special url link or code is used. This link or code is generated upon the request and sent to an email address that was previously specified by the subject of risk-taking. When a password reset is requested, the required link or code is sent to the predetermined email address. In some embodiments, the proxy server 220 uses access to the qualified account provider 270 to substitute an email address that is controlled by the proxy server 220 for the one specified by the subject of risk-taking 100. After the change, password reset requests by the subject of risk-taking 100 may not be completed by the subject of risk-taking 100 because the subject of risk-taking does not have access to the email with the required link or code. Furthermore, the proxy server 220 may now process password reset requests if necessary to regain control of the qualified account.

Since the user logs in through the proxy server 220, the proxy server 220 may monitor how often the subject of risk-taking 100 logs into the qualified account at the qualified account provider 270. If the subject of risk-taking 100 rarely logs in that may be a sign that this is a dummy account that the user submitted for the purpose of the loan or insurance policy or that they do not use the account frequently enough to be useful for information.

Since the subject of risk-taking 100 does know the credentials 202, they are dependent on the proxy server 220 to obtain access to the qualified account 220. In some embodiments, the qualified account at the qualified account provider 220 may be used as collateral for the loan per the loan agreement. If the loan is in default according to a generally accepted definition of that term or according to the terms of the loan agreement, the proxy server 220 may refuse to permit the subject of risk-taking 100 to access the qualified account at the qualified account provider 270 until the subject of risk-taking 100 resolves the default. In other cases, the subject of risk-taking 100 may allow access that is limited by the proxy server 220. For example, the proxy server 220 may not allow the subject of risk-taking 100 to use certain features or capabilities in the qualified account until the subject of risk-taking 100 resolves the default. In other cases certain intellectual property, such as pictures owned by the subject of risk-taking 100, may be made inaccessible or may be removed from the qualified account and stored in the database 132 or the database 565 until the default is resolved. In fact, ownership of this intellectual property may be transferable to the risk-taking entity 100 in certain circumstances under the loan agreement.

Since the proxy server 220 acts as an intermediary between the subject of risk-taking 100 and the qualified account provider 270, the proxy server 220 may restrict or control actions that the subject of the risk-taking may perform to circumvent or compromise the access and control granted as a condition of the loan or insurance-policy agreement. For example, the proxy server 220 may not pass on requests by the subject of risk-taking 100 to change their password, reset the password, or change permissions granted to the proxy server 220.

In some embodiments, the proxy server 220 also acts an intermediary for other qualified accounts at the qualified account provider 270 or at another qualified account provider, such as qualified account provider 280. Proxy server 220 may handle the credentials 201 for a qualified account at qualified account provider 280 by creating and managing credentials 203 in a similar way as described with respect to credentials 200 and credentials 202.

The stability server 130 may access the qualified accounts of qualified account provider 270 and qualified account provider 280 through the proxy server 220. The stability server 130 may host the proxy server 220 or may have a physically secure network connection to the proxy server such that authentication is not necessary for the communication link. In some embodiments, the stability server 130 provides authentication credentials to the proxy server 220 to establish a communications link.

Once the communications link is established, the stability server 130 may access the qualified accounts of the qualified account provider 270 and the qualified account provider 280 without providing credentials 200 and credentials 201 as would be required from the subject of risk-taking 100. Due to the privileged access of the stability server 130, the proxy server 220 grants access to the qualified accounts by logging into the qualified account provider 270 and the qualified account provider 280 using credentials 201 and credentials 203 on behalf of the stability server 130. In some cases, the proxy server may filter or limit access based on the terms of the loan or insurance policy.

The proxy server 220 may use the credentials 202 to obtain access that may not be available using other methods of access, such as access tokens. In some embodiments, the proxy server 220 may use the credentials 202, including user id, password and question-and-answer pairs, to log into the qualified account at the qualified account provider 270 even when the subject of risk-taking 100 is not currently logging in through the proxy server 220.

For example, the proxy server 220 may be able to check access permissions in a way that allows the proxy server 220 to determine what is or is not being shared as compared to access granted to the application by an access token, for example. A superset of information may be accessible through the use of credentials 202 as compared to what is grantable through normal third-party access permissions by the qualified account provider 270. In some embodiments, even though all account information may be available to the proxy server 220, filters and access restrictions may be applied so that only information allowed per the loan agreement is passed on to be received by the stability server 130. These filters and access restrictions may also be applied to comply with privacy laws and other legal restrictions.

The proxy server 220 may also manage credentials for one or more information providers. In some embodiments, the information provider 290 may be the financial information provider 150, the legal information provider 152, the medical information provider 154, the news provider 156, the public records provider 158, the credit reporting agency 159, or the crowdsourced opinion provider 160. Whether or not these information providers charge a fee for access, the information provider 290 may require an account with credentials 204 to access some or all of the information they provide. In some cases, the information provider 290 may charge a fee for such access.

After the risk-taking period is completed, the proxy server 220 may restore credentials 202 to be consistent with credentials 200 so that the subject of risk-taking 100 can directly log into the qualified account of the qualified account provider 270. The proxy server 220 may also change credentials 203 to be consistent with credentials 201 so that the subject of risk-taking 100 can directly log into the qualified account of the qualified account provider 280. At that point, the subject of risk-taking 100 can change the password for each qualified account to one not shared with the proxy server 220 thereby preventing further access by the proxy server 220 or the stability server 130.

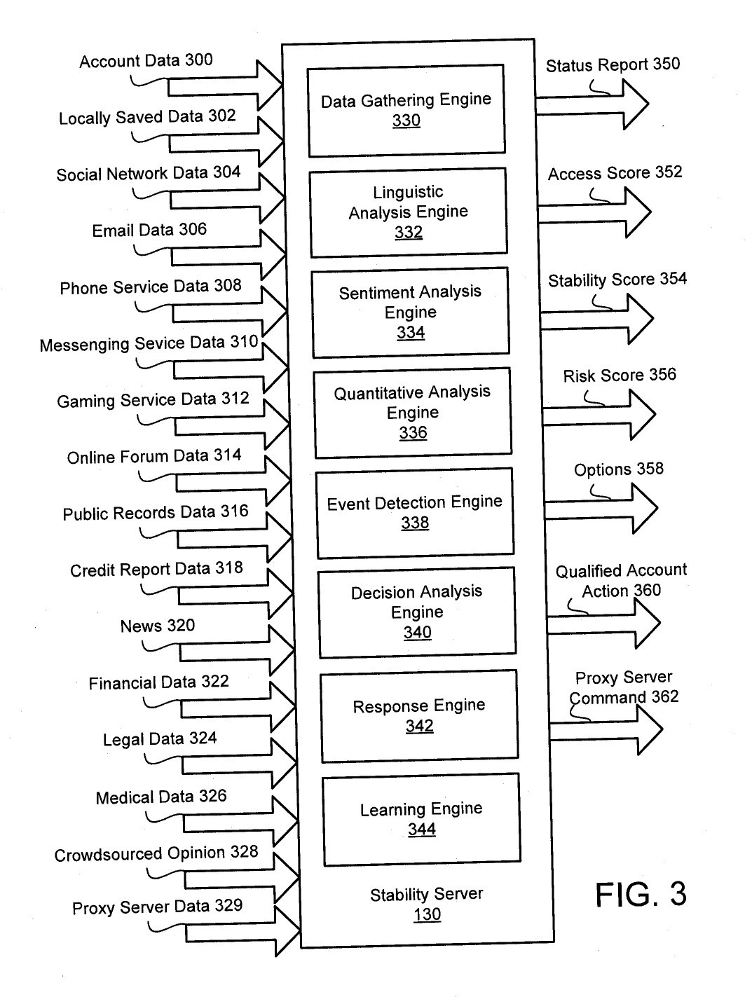

FIG. 3 shows an embodiment of a logical diagram of the stability server 130. A data gathering engine 330 is configured to use one or more network interfaces to retrieve information from sources such as qualified account providers, information providers, and local databases. In some embodiments, the data gathering engine 330 connects to the qualified account providers and the information providers through the proxy server 220.

The retrieved information may include account data 300 related to the risk-taking scenario of the subject of risk-taking 100. In some embodiments, account data 300 may include information from the loan or insurance application, contract terms, transaction history including payments, and a record of previous communications and actions regarding the risk-taking scenario of the subject of risk-taking 100.

The retrieved information may include locally-saved data 302. The locally-saved data 302 may include information stored in the database 132 and the database 262. In some embodiments, the locally-saved data 302 may include access tokens and credentials used to obtain access to qualified accounts and other information sources, previously collected data, previously produced analysis of that previously collected data, and previously generated reports.

The received data may include social network data 304. The social network data 304 may include information received from the social network provider 140. In some embodiments, the social network data 304 may include status updates, profile information, “wall” postings, messages, pictures, contact information of the subject of risk-taking 100 and his or her connections within the social network, and other information accessible within the social networks of the subject of risk-taking 100.

The received data may include email data 306. The email data 306 may include information received from the email service provider 142. In some embodiments, the email data 306 may include email messages, contact information such as email addresses and phone numbers of the contacts of the subject of risk-taking 100, and schedule information such as calendar appointments, and other information accessible within email accounts of the subject of risk-taking 100.

The received data may include phone service data 308. The phone service data 308 may include information received from phone service provider 144. In some embodiments, the phone service data 308 may include voicemails and text messages, contact information such as email addresses and phone numbers, and schedule information such as calendar appointments, and other information accessible within the phone service accounts of the subject of risk-taking 100.

The received data may include messaging service data 310. The messaging service data 310 may include information received from the messaging service provider 146. In some embodiments, the messaging service data 310 may include text-based messages such as instant messages, contact information such as email addresses and phone numbers, and other information accessible within the messaging service accounts of the subject of risk-taking 100.

The received data may include gaming service data 312. The gaming service data 312 may include information received from the gaming service provider 148. In some embodiments, the gaming service data 312 may include gaming activity such as revenues and losses from gambling, communication made between game players about real life events, and other information accessible within the gaming service accounts of the subject of risk-taking 100.

The received data may include online forum data 314. The online forum data 314 may include information received from the online forum provider 149. In some embodiments, the online forum data 314 may include discussions within online forums about company review sites, product review sites, restaurant review and recipe sharing sites, dating services, and health information sites.

The received data may include public records data 316. The public record data 316 may include information received from the public records provider 149. In some embodiments, the public record data 316 may include public records such as title transfers and liens published by a county recording office and associated with the subject of risk-taking 100.

The received data may include credit report data 318. The credit report data 318 may include information received from the credit reporting agency 149. In some embodiments, the credit report data 318 may include Equifax, TransUnion and Experian credit reports associated with the subject of risk-taking 100.

The received data may include news 320. The news 320 may include information received from the news database 156. In some embodiments, the news 320 may include information about general economic conditions, the employer of the subject of risk-taking 100, the location of the residence of the subject of risk-taking 100, or the risk-taking scenario of the subject of risk-taking 100.

The received data may include financial data 322. The financial data 322 may include information received from the financial database 150. In some embodiments, the financial data 322 may include financial data about general economic conditions, the employer of the subject of risk-taking 100, the business or home of the subject of risk-taking 100, or the risk-taking scenario of the subject of risk-taking 100.

The received data may include legal data 324. The legal data 324 may include information received from the legal database 152. In some embodiments, the legal data 324 may include litigation data or other legal information about the subject of risk-taking 100, the employer of the subject of risk-taking 100 or the risk-taking scenario of the subject of risk-taking 100.

The received data may include medical data 326. The medical data 326 may include information received from the medical database 154. In some embodiments, the medical data 326 may include medical history of the subject of risk-taking 100 and general information about symptoms, diagnosis, prognosis and costs of medical conditions to ascertain the implication of potential medical conditions of the subject of risk-taking 100 and those people for which they financially rely or are financially responsible.

The received data may include crowdsourced-opinion data 328. The crowdsourced-opinion data 328 may include information received from the crowdsourced-opinion provider 160. In some embodiments, the crowdsourced opinion data 228 may include crowdsourced opinions that are based on some or all of the received data about the subject of risk-taking 100. Crowdsourced opinion data 328 may include, for example, an opinion about a recommended course of action, such as a choice between several options, or a ranking or rating used as a factor in a determination made by the stability server 130.

The received data may include proxy server data 329. The proxy server data 329 may include information received from the proxy server 220. In some embodiments, the proxy server data 329 may include information such as the frequency that the subject of risk-taking 100 uses each qualified account or the amount of time the subject of risk-taking 100 spends logged in to each of the qualified accounts.

Other categories of received data and other types of received data within each of the exemplary categories may be used according to the inventive subject matter. In some cases, received information could be classified in more than one category. For example the cost of a particular medical treatment may be considered medical data and financial data. The received data may be analyzed in many different ways according to the inventive subject matter.

Embodiments of the stability server 130 use the received information to detect or predict events or issues that may affect performance of the loan, insurance policy or other risk-taking scenario. Embodiments of the stability server 130 use the received information and access to qualified accounts to evaluate, control, influence or assist the subject of risk-taking 100 in meeting their obligations under the loan, insurance policy, or other risk-taking scenario. The stability server 130 may use the received data to generate a status report 350, an access score 352, a stability score 354, a risk score 356, options 358, a qualified account action 360, or a proxy server command 362, for example.

Embodiments of the stability server 130 include a linguistic analysis engine 332 that extracts relevant information from the received information using speech recognition and natural language processing. Speech recognition may be applied to received information that is in audio form to convert it to text form. Natural language processing may be applied to received information and the output of speech recognition to extract the meaning of the received information.

Embodiments of the stability server 130 include a linguistic analysis engine 332 that extracts relevant information from the received information using speech recognition and natural language processing. Speech recognition may be applied to received information that is in audio form to convert it to text form. Natural language processing may be applied to received information and the output of speech recognition to extract the meaning of the received information.

The system may monitor communications such as “wall” posts and emails in the qualified accounts. If the frequency of the word “cancer,” “hospital” or “surgery” is used frequently, linguistic analysis might be used to determine whether it indicates the applicant or someone else that they might depend on or be responsible for, has been diagnosed with an illness that might impact the ability of the borrower to repay the loan. For example, as the frequency of the word “cancer” increases in communications contained in the received information, a statistical model may indicate an increasing probability that the subject or risk-taking 100 or someone close to them has cancer. A linguistic analysis of the communications within the received information may help determine who, if anyone, is associated with the use of the word cancer in these communications. For example, an analysis of sentence structure and other linguistic analysis may indicate that the cancer patient is a distant relative or a fictional character in a movie. This analysis may result in an increasing estimate of the probability that the person who has cancer is not the subject of risk-taking 100 or someone he or she depends on or is responsible for. Therefore, this cancer may have little impact on the performance of the loan or insurance policy. Low confidence levels for particular determinations may prompt the data gathering engine to specifically search for information that may be used to generate a better confidence level. As more received information is collected, more analysis may be performed and confidence levels, probabilities, and predictions may be updated.

Similar analysis may be applied to other key factors. Work-related issues, such as job loss or change of employer, may impact performance of a loan. For example, the subject of risk-taking 100 may not be able to make loan payments as a result of the job loss. A person starting in a new job may statistically be more likely to lose that job as compared to someone that has been at a job for a while. Increased probability of job loss may indicate an increased probability of default or other loan performance problems. However, received information may indicate that the new job may come with increased salary or is at an employer that is in a better financial position than the previous employer. This information may reduce the estimated probability of loan performance problems.

Relationship events, such as marriage and divorce, may impact performance of a loan or insurance policy. For example, the stability and financial position of the subject of risk-taking 100 may be improved by marriage as a result of the shared assets, shared responsibility and joint decision making. Alternatively, the financial position of the subject of risk-taking 100 may be compromised by assets lost and alimony payable in a divorce settlement. Increased probability of divorce may increase the probability of default or other loan performance problems. However, received information may indicate that the divorcing spouse of the subject of risk-taking 100 had significantly worse credit history than the subject of risk-taking 100 or other issues that may indicate that the subject of risk-taking 100 will be better able to meet their financial obligations after the divorce.

Other life events may be detected or predicted. For example, the linguistic analysis may detect with a certain confidence level that the subject of risk-taking 100 has bought a house, moved to a new city, has a pregnant wife, started smoking cigarettes, became widowed, started or shut-down a business, started attending school, defaulted on other loans, inherited assets or is considering filing for bankruptcy. In some cases, the linguistic analysis may predict these events will happen within a certain period of time with a certain estimated probability level. These events and others like them may have implications for the performance of a loan or insurance policy or other risk-taking scenario. What events and issues are relevant and how much they impact performance is determined in part by the details of the risk-taking scenario and the terms of any agreements between the risk-taking entity 120 and the subject of risk-taking 100.

The data gathering engine 330 may subsequently seek information from the qualified accounts, other information providers or the local database to supplement any interpretations of received data. This supplemental information may reinforce the previous interpretation to a confidence level that exceeds a predetermined threshold. The stability server 130 may automatically act based on that interpretation when the predetermined confidence threshold is met or exceeded. For example, the stability server 130 might initially determine that there is a small probability of divorce based on some keywords in the received information, but subsequently received information might cause the stability server 130 to raise the estimated probability. In some cases, the subsequent information may cause the stability server 130 to lower the estimated probability of the previous interpretation. Eventually, the received information may include definitive information that the detected or predicted event occurred, such as confirmation of a divorce through public records or news articles.

Embodiments of the stability server 130 include a sentiment analysis engine 334 that extracts subjective or emotional information from the received information. This may be used to understand the attitude of the speaker or writer in each communication with respect to a relevant issue. For example, sentiment analysis may be used to understand how optimistic or pessimistic the communicator is about the discussed topic in order to gauge how likely this issue might impact the performance of the loan or insurance policy. Sentiment analysis may also be used to evaluate crowdsourced information by interpreting the attitude of those offering their opinion.

Embodiments of the stability server 130 include a quantitative analysis engine 336 that extracts relevant information from the received information. In some embodiments, the quantitative analysis engine 336 may be used to compute statistical measures, scores and other indicators, numerical trends and other relevant quantitative information. The quantitative analysis engine 336 may apply statistical and other mathematical models to the received information to generate confidence levels and predicted probabilities of certain events or issues. In some embodiments, the quantitative analysis engine 336 may apply statistical and other mathematical models to the received information to generate the access score 352, the stability score 354 and the risk score 356. The access score 352, stability score 354 and the risk score 356 may be based in part on linguistic analysis, sentiment analysis, quantitative analysis and event detection based on the received information.

In some embodiments, the status report 350 is sent to the risk-taking entity 120 as an update on the status of the risk-taking scenario. In some embodiments, the status report 350 may include a current accounting of the loan or insurance policy, events and issues that the stability server 130 has recently detected, the confidence level that the events and issues have been accurately detected, and the probability that predicted events and issues may happen within a specified period of time. In some embodiments, the confidence levels and probabilities are based on statistical models of the relationship between observations made based on the received information and possible determinations or outcomes. In some embodiments, the status report 350 includes predicted and detected events and provides for the risk-taking entity 120 to approve various options 358. For example, if the subject of risk taking 100 has had or is about to have a baby, or has recently gotten married, the stability-server 130 might suggest that the risk-taking entity 120 offer to sell life insurance to the subject of risk-taking 100. If the subject of risk-taking 100 has recently gotten a job, the stability-server 130 might suggest that the risk-taking entity 120 offer retirement savings accounts to the subject of risk-taking 100.

In some embodiments, the access score 352 is a numeric indicator based on the received information from the qualified accounts, the information providers and the local databases. In some embodiments, the access score 352 is an indicator of the expected value of the access to the qualified accounts of the subject of risk-taking 100. For example, the access score 352 may be based on the extent of access permissions granted, the number of contacts in each of the qualified accounts; the frequency, duration and recency of use of each qualified account by the subject of risk-taking 100; the frequency and recency of posted messages in the qualified account made by the subject of risk-taking 100 and his or her contacts; and a qualitative evaluation of the content of the messages such as determining whether they include substantive discussion of the life of the subject of risk-taking 100 or just polite talk about the weather. Generally, the access will be more valuable when the access permissions are more open, the social network more extensive and the conversations more frequent, recent and substantive. In some embodiments, the access score 352 may be used to determine whether to offer preferred terms for access to the qualified accounts and, in some cases, select between various degrees of preferred terms depending on the access score 352. For example, if the access score 352 is below a first predetermined value, preferred terms are not offered in exchange for access to the qualified accounts. If the access score 352 is above the first predetermined value but below a second predetermined value, preferred terms are offered in exchange for access to the qualified accounts. If the access score 352 is above the second predetermined value, even better preferred terms are offered in exchange for access to the qualified accounts.

In some embodiments, the stability score 354 is a numeric indicator based on the received information from the qualified accounts, the information providers and the local databases. In some embodiments, the stability score 354 is an indicator of the expected risk in the risk-taking scenario of the subject of risk-taking 100. The stability score 354 may change each time the stability server 130 reassesses the stability score 354 using more received information later in the period of the risk-taking scenario. In some embodiments, the stability server 130 makes the decision as to whether to approve a loan or insurance policy based at least in part of the stability score 354. In some embodiments, the stability server 130 makes decisions as to what actions to take with respect to the loan or insurance policy based at least in part on the stability score 354. For example, if the stability score 352 is low or has been trending down, the stability server 130 may respond by attempting to evaluate, control, influence or assist the subject of risk-taking 100 according to the inventive subject matter.

If the risk-taking entity 120 lends money to the subject of risk-taking 100, the stability score 354 may be an indication, at the time of scoring, of the probability that the loan will be paid as agreed. In some embodiments, the stability score 354 may be an indication of the probability that there will not be a default in a certain period of time, such as the next six months or before the loan is paid in full. In some embodiments, the stability score 354 may be quantified in terms of the expected return of the loan as of the date of scoring based on an estimated probability distribution of various potential outcomes. In one embodiment, the net present value of each potential series of cash flows would be multiplied by the estimated probability of that cash flow stream. In some cases, this model might be simplified by using a limited number of representative potential outcomes. For example, one potential outcome might be that the loan is paid-as-agreed for the balance of the payments resulting in the ideal expected value. Another potential outcome is that no payments are ever made and that a certain amount of money is expended in administrative and collection efforts resulting in a worst-case expected value. Other representative outcomes might be spaced equally in terms of net present value between these extreme potential outcomes. For example, representative outcomes might be assigned net present values that are 25 percent, 50 percent and 75 percent of the way between the net present values of the worst-case outcome and ideal expected outcome. The model would then estimate probabilities that the outcome has a net present value that is closest to each of these representative outcomes to compute the expected value. In some embodiments, the expected return includes the payments that have been made to date.

In some embodiments, the expected return does not include past payments. The expected return might be compared to the amount of money currently at risk. For example, at a given time during the loan period the amount of money at stake would be the current loan balance. At the beginning of the loan period, the entire loan amount is at risk because no payments have been made. After many installment payments, some principal is returned and therefore less money is at risk. At the same time, the expected return of future payments is less because there are less payments left to be made.

In some embodiments, the risk score 356 is a numeric indicator based on the loan application and credit reports. The risk score 356 may be a FICO™ score, Equifax Credit Score™, Experian Plus™ score, Vantagescore™ and other numerical indicators based on a statistical analysis of credit report data to be an indication of creditworthiness. In some embodiments, the risk score 356 incorporates a statistical analysis of loan application data, such as income, length of time at their job, length of time at their residence, combined with one or more credit scores, as an indication of creditworthiness.

Embodiments of the stability server 130 include an event detection engine 338 that may use received information to detect or predict events and issues. The event detection and prediction may be based at least in part on the linguistic analysis, sentiment analysis and quantitative analysis of the received information. In many cases, there is a tradeoff between the confidence level or predicted probability and the timeliness of detecting or predicting an event.

Embodiments of the stability server 130 include a decision analysis engine 340 that may use received information based on that received information to make decisions. The decisions may be based in part on linguistic analysis, sentiment analysis, quantitative analysis and event detection based on the received information. The threshold level required to act based on that information may depend on the kind of event or issue and the particular action being evaluated. For example, if the early detection or prediction of a certain kind of event or issue will be particularly useful in controlling, influencing or assisting the subject of risk-taking 100 in meeting their obligations in the risk-taking scenario, the threshold might tend to be set lower to provide for earlier action in response to detection or prediction. For example, if the subject of risk-taking 100 has defaulted and is predicted to relocate to another country, it might make sense to aggressively pursue collection efforts while he or she still has assets in the jurisdiction even though the prediction is only made to a low degree of confidence. However, as the expected negative consequences of acting on an inaccurate detection or poor prediction increase, the threshold for action might be set higher. For example, if the action considered is to post a message viewable by one or more of the subject of risk-taking 100 and that message may be defamatory, if incorrect, then a high threshold for action may be used and an alternative action, such as a private message to the subject of risk-taking 100, may be used when the threshold is not met. In many cases, the consequences for incorrect detection may be small. For example, the received information may indicate that the subject of risk-taking 100 is about to relocate to a different city. The stability server 130 may send a private email message to the subject of risk-taking 100 asking that he or she confirms this and, if true, provide the new address and the expected date of the relocation.

Embodiments of the stability server 130 include a response engine 342 that responds based on the received information. These decisions may be based in part on the confidence levels of various predicted or detected events, and the tradeoffs between the benefits of early response and the consequences of responses based on inaccurate predictions or detections. In some embodiments, the stability server 130 may report the relevant facts to the risk-taking entity 120 for approval of the contemplated actions when the consequences of inaccurate prediction of detection might be significant. Embodiments of the stability server 130 include a decision analysis engine 340 that may use received information based on that received information to make decisions. The decisions may be based in part on linguistic analysis, sentiment analysis, quantitative analysis and event detection based on the received information.

Embodiments of the stability server 130 include a learning engine 344 that automatically improves the models used for linguistic analysis, sentiment analysis, quantitative analysis, event prediction and detection, decision analysis and responses. These improvements may be based on correlations of the outcomes of previous analysis. For example, if certain factors are found to overestimate the likelihood of a certain event based on failed predictions, the model's weighting of those factors might be reduced for future predictions. Certain factors that were not incorporated in the model may subsequently be incorporated if they are found to be predictive of relevant outcomes.

As described above, the stability server 130 may generate the status report 350, the access score 352, the stability score 354, and the risk score 356.

In some embodiments, the response engine 342 may generate options 358. In some embodiments, options 358 may be an indication of one of several choices, such as the option to approve a loan and the option to deny a loan. In some embodiments, options 358 may be an indication of several choices from which one or more must be selected, such as standard loan terms without access to qualified accounts and preferred loan terms with access to qualified accounts. In some embodiments, options 358 may indicate options such as a ranking or rating of the risk or other characteristic of the subject of risk-taking 100.

In some embodiments, the stability server may also generate a qualified-network action 360. The qualified network action 360 may be some action in one or more qualified networks. For example, the qualified account action 360 may be sending an email to subject of risk-taking 100 through the social network provider 140 or through the email service provider 142 or both. The email may inquire about detected events and issues or request that the subject of risk-taking 100 take some action to address the detected event or issue.

In some embodiments, the qualified account action 360 may be making a posting on the “wall” of the qualified account of subject of risk-taking 100, or other place in which one or more contacts of the subject of risk-taking 100 may see the posting. The posting may include a statement or inquiry about detected events and issues. In some cases, the subject of risk-taking may be more effectively motivated when the statement is readable by others. In some cases, one or more of the contacts of the subject of risk-taking 100 may be able and willing to help the subject of risk-taking 100 with respect to the detected events of issues, and would not have known about the problem but for the posting by the stability server 100.

In some embodiments, the email or posting provides information and resources for the subject of risk-taking 100 to effectively address the detected events or issues. For example, if the subject of risk-taking 100 is smoking under a non-smoking health insurance policy, the stability server 100 may provide information about techniques and services that help people quit smoking. The stability server 130 might also email the subject of risk-taking 100 to inform him or her that they are need to stop smoking or switch to a higher premium policy for smokers.

In some embodiments, the stability server 130 may issue a proxy server command 360. The proxy server command 360 may indicate that the proxy server 220 should impose certain limitations to access by the subject of risk-taking 100 in one or more of their qualified accounts. For example, the stability server 130 might impose these access limitations when the subject of risk-taking 100 is not complying with the terms of the loan or insurance policy. These access limitations may reduce the value that the subject of risk-taking 100 receives from these qualified accounts and therefore motivate him or her to promptly address the failure to meet the terms of the loan or insurance policy. In some embodiments, the stability server 130 issues a proxy server command 360 when the subject of risk-taking 100 addresses the failure to meet the terms of the loan or insurance policy. For example, the subject of risk-taking 100 may make payments to bring a loan current. The proxy server command 360 may revoke the previously imposed access limitations in response to the payment by the subject of risk-taking 100.

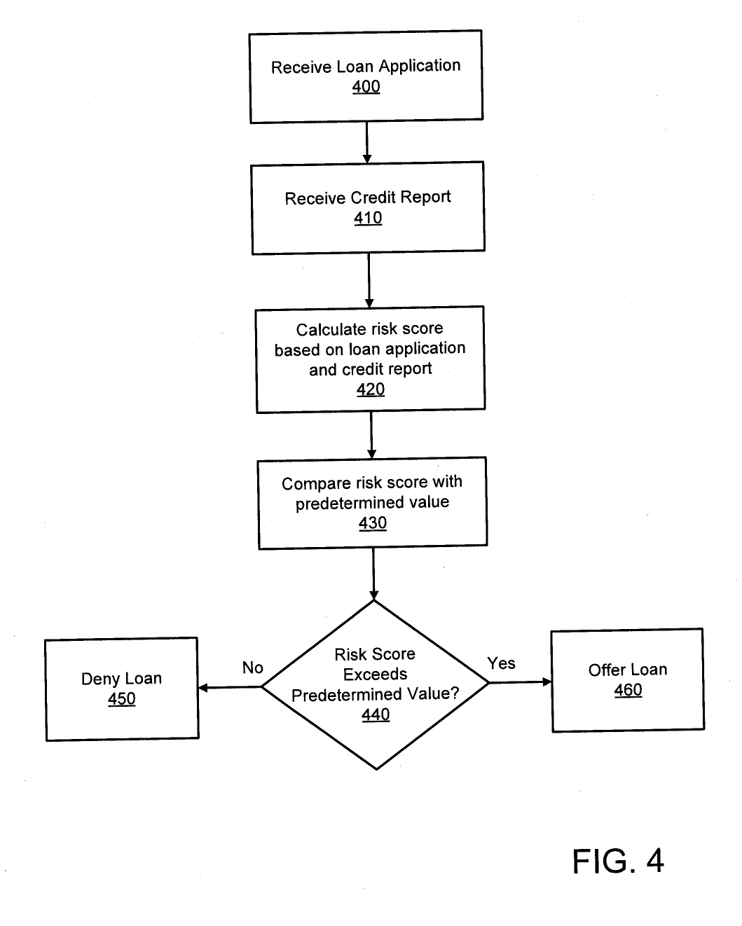

FIG. 4 shows an embodiment of a method to evaluate a loan or insurance policy application according to the inventive subject matter.

In step 400, a loan application is received through an online mechanism. In some embodiments, the subject of risk-taking may submit an electronic loan application the risk-taking entity 120 or at the micro-lending market 170. This loan application may be transmitted from the risk-taking entity 120 or the micro-lending market 170 to the stability server 130. In other embodiments, the subject of risk-taking may submit the loan application directly to the stability server 130 operating on behalf of the risk-taking entity 120 or the micro-lending market 170.

In step 410, a credit report is received. For example, the risk-taking entity 120 may request a credit report for the subject of risk-taking 100 from the credit reporting agency 159 and subsequently receive that credit report.

In step 420, a risk score is computed based on information from the loan application and the credit report. The risk score is an indication of the credit risk of the subject of risk-taking 100.

In step 430, the risk score is compared against a predetermined value to determine if the loan should be approved. For example, if higher risk scores indicate better credit risk, the credit risk will be assumed to be acceptable when the risk score exceeds the predetermined value.

In step 440, it is determined if the risk score exceeds the predetermined value. If the risk score does not exceed the predetermined value, step 450 is performed. If the risk score does not exceed the predetermined value, step 460 is performed.

In step 450, the loan is denied.

In step 460, the loan is approved.

In some embodiments, there may be several predetermined values indicating several thresholds of credit risk. If the risk score does not exceed the lowest value, the loan may be denied. If the risk score exceeds the lowest threshold value, the loan will be approved. If the risk score exceeds each successively higher threshold value, the loan may be approved with increasingly better terms, such as lower interest rates.

In some embodiments, an insurance policy may be received and the risk score is an indication of insurance risk. The insurance policy may be approved or denied depending on whether the risk score exceeds the lowest predetermined value. As the risk score exceeds successively higher threshold values, the insurance policy may be approved with increasingly better terms, such as lower insurance premiums.

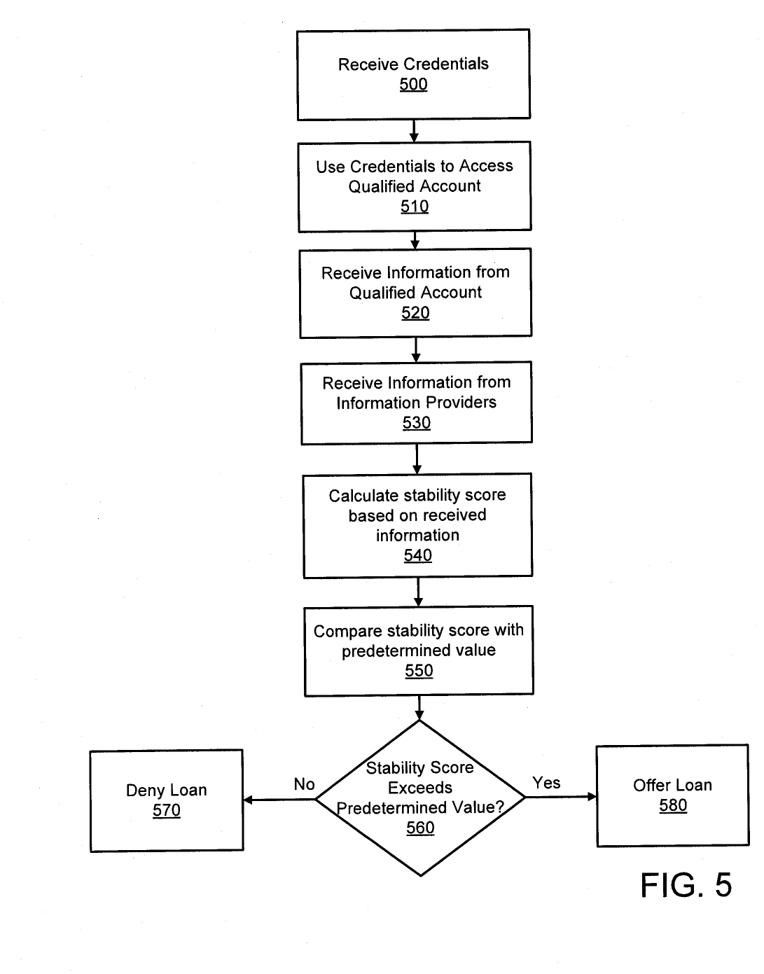

FIG. 5 shows an embodiment of a method to evaluate a loan or insurance policy application according to the inventive subject matter.

In step 500, credentials are received. The credentials may be provided by the subject of risk-taking as part of the application process.

In step 510, the credentials are used to access one or more qualified accounts.

In step 520, information is received from the one or more qualified accounts. The received information may be social network information, email messages, phone service information, messaging service information, gaming service information, online forum information, and other information available from the qualified account providers.

In step 530, information is received from one or more information providers. The received information may be financial information, legal information, medical information, news, public records, credit reports, crowdsourced opinions, and other information available from the information providers.

In step 540, a stability score is computed based on the received information. The stability score is an indication of the risk in the subject of risk-taking 100.

In step 550, the stability score is compared against a predetermined threshold to determine if the loan should be approved.

In step 560, it is determined if the risk score exceeds the predetermined value. If the risk score does not exceed the predetermined value, step 570 is performed. If the risk score does not exceed the predetermined value, step 580 is performed.

In step 570, the loan is denied.

In step 580, the loan is approved.

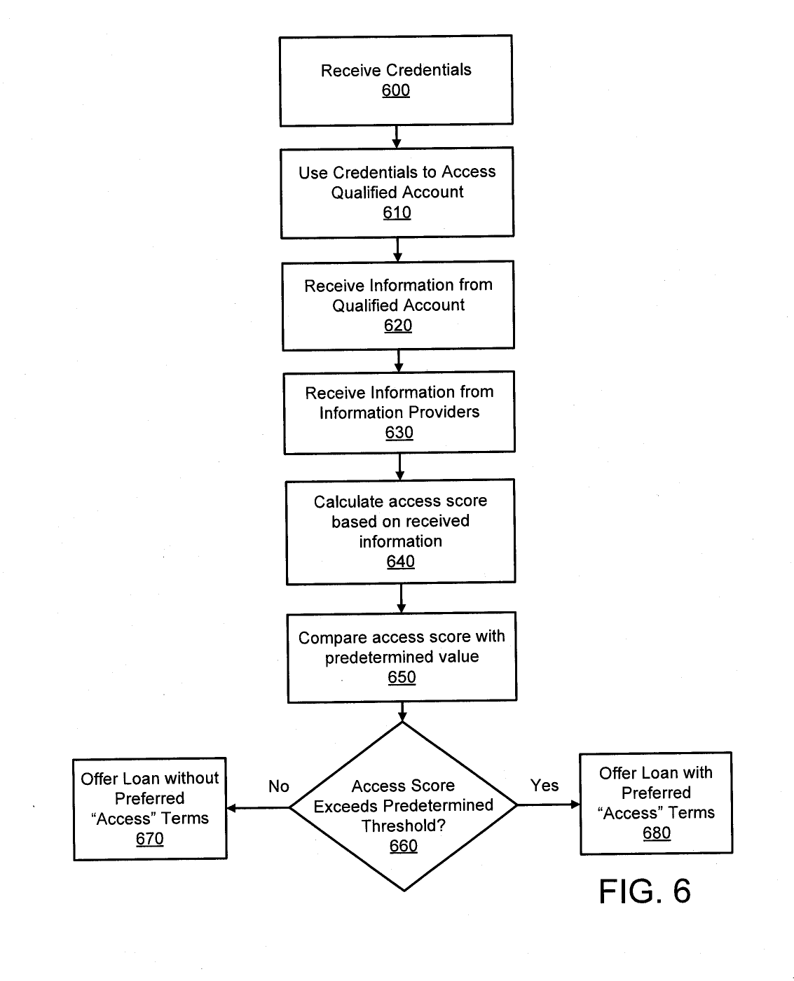

In some embodiments, the process of FIG. 6 is performed to determine if preferred “access” terms should be offered.

In some embodiments, there may be several predetermined values indicating several thresholds of risk. If the stability score does not exceed the lowest value, the loan may be denied. If the stability score exceeds the lowest threshold value, the loan will be approved. If the stability score exceeds each successively higher threshold value, the loan may be approved with increasingly better terms, such as lower interest rates.

In some embodiments, an insurance policy may be received and the stability score is an indication of insurance risk. The insurance policy may be approved or denied depending on whether the stability score exceeds the lowest predetermined value. As the stability score exceeds successively higher threshold values, the insurance policy may be approved with increasingly better terms, such as lower insurance premiums.

FIG. 6 shows an embodiment of a method to evaluate the value of access to qualified accounts of a subject of risk taking according to the inventive subject matter.

In step 600, credentials are received.

In step 610, the credentials are used to access one or more qualified accounts.

In step 620, information is received from one or more qualified accounts.

In step 630, information is received from the information providers.

In step 640, an access score is computed based on the received information. The access score is an indication of the expected value of access to the qualified accounts of the subject of risk-taking 100.

In step 650, the access score is compared against a predetermined threshold to determine if the preferred access terms should be offered.

In step 660, it is determined if the access score exceeds the predetermined value. If the access score does not exceed the predetermined value, step 670 is performed. If the risk score does not exceed the predetermined value, step 680 is performed.

In step 670, the loan is offered without preferred access terms. The subject of risk-taking 100 is not offered preferential terms in exchange for ongoing access to their qualified accounts.

In step 680, the loan is offered with preferred access terms. In some embodiments, the applicant is given the choice of accepting the loan with access terms (and providing access to their qualified accounts) or accepting the loan without access terms (and withholding access to their qualified accounts).

In some embodiments, there may be several predetermined values indicating several thresholds of expected value for qualified account access. If the access score does not exceed the lowest value, preferential terms may not be offered for qualified account access. If the access score exceeds the lowest threshold value, the preferential terms will be offered in exchange for ongoing access to their qualified accounts. If the access score exceeds each successively higher threshold value, increasingly better terms such as lower interest rates, may be offered for ongoing access to their qualified accounts.

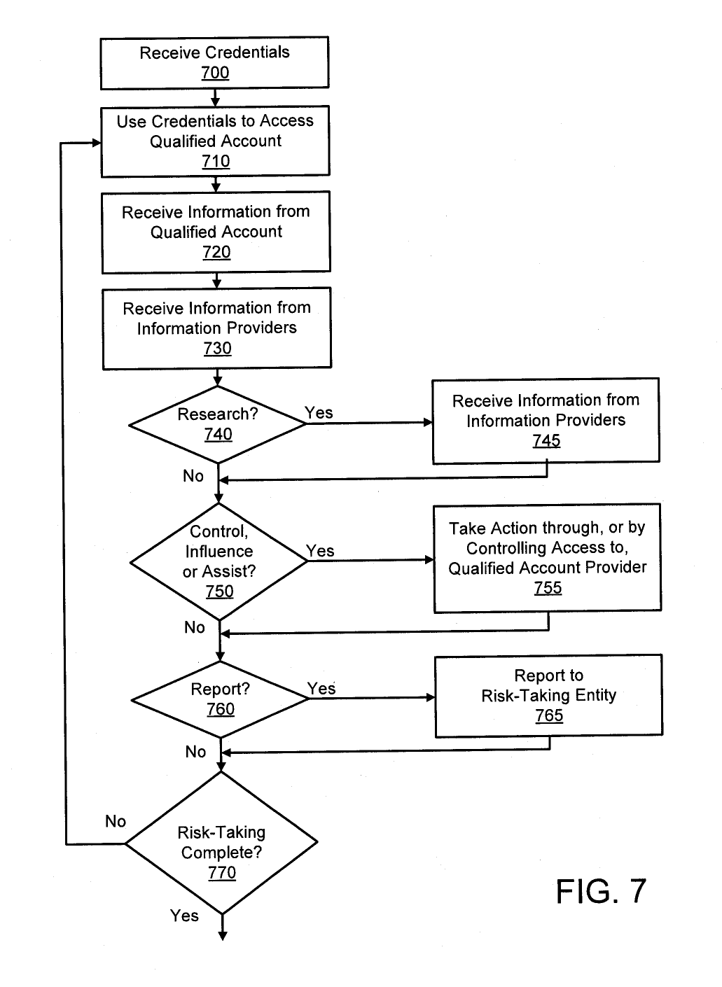

FIG. 7 shows an embodiment of a method to monitor the performance of a loan or insurance policy.

In step 700, one or more a credentials of the subject of risk-taking 100 are received. In some embodiments, the credentials include the access token 134 of the subject of risk-taking 100. In other embodiments, the authentication credentials include the user id 106 and password 108 of the subject of risk-taking 100. The authentication credentials may include any information necessary to obtain access to one of the qualified accounts of the subject of risk-taking 100. In some embodiments, these credentials may be received during the application process. In other embodiments, these credentials are received after approval of the loan or insurance policy.

In step 710, the credentials are used to obtain access to one or more qualified accounts.

In step 720, information from one or more qualified account providers is received.

In step 730, information from one or more information providers is received.

In step 735, information from qualified accounts are evaluated to detect or predict events or issues that may affect performance of the loan or insurance policy. For example, the analysis may detect or predict financial problems, or health issues, that may affect performance of the loan or insurance policy.

In step 740, a determination is made as to whether any further research is required. For example, the detected issue may be the declining value of a particular stock holding or a particular type of cancer. A determination may be made to research the stock or the cancer to estimate its potential impact on performance of the loan or insurance policy. If the determination is made to perform research, step 745 is performed. Otherwise, step 750 is performed.

In step 745, research is performed. Research on the stock may be performed by accessing a financial information provider to obtain analyst predictions for performance of that stock. The research on the particular type of cancer may be performed by accessing a medical information provider to receive prognosis information based on characteristics of the subject of risk-taking 100.

In step 750, a determination is made as to whether any response should be made to control, influence or assist the subject of risk-taking 100 in meeting their obligations under the loan agreement or the insurance policy agreement. If a response should be made, step 755 is performed. Otherwise, step 760 is performed.

In step 755, an action is taken through a qualified account to control, influence or assist the subject of risk taking.

In step 760, a determination is made as to whether to send a report to the risk-taking entity 120 about the status of the loan or insurance policy, including detected or predicted events and issues that may affect performance of the loan or insurance policy. If a report should be sent, step 765 is performed. If a report should not be sent, step 770 is performed.

In step 765, a report is sent to the risk-taking entity 120.

In step 770, a determination is made as to whether the risk taking is complete. For example, the risk-taking may be complete under a loan when the loan is paid-in-full. In some cases this may be as scheduled under the loan agreement, but in other cases it may be shortened due to early payments or lengthened due to late payments. The risk-taking may be complete under an insurance policy when the period of coverage is completed. In some cases, the period of coverage may be shortened due to early cancellation. If the period of risk taking is not completed, step 710 is performed. Otherwise, the process is completed.

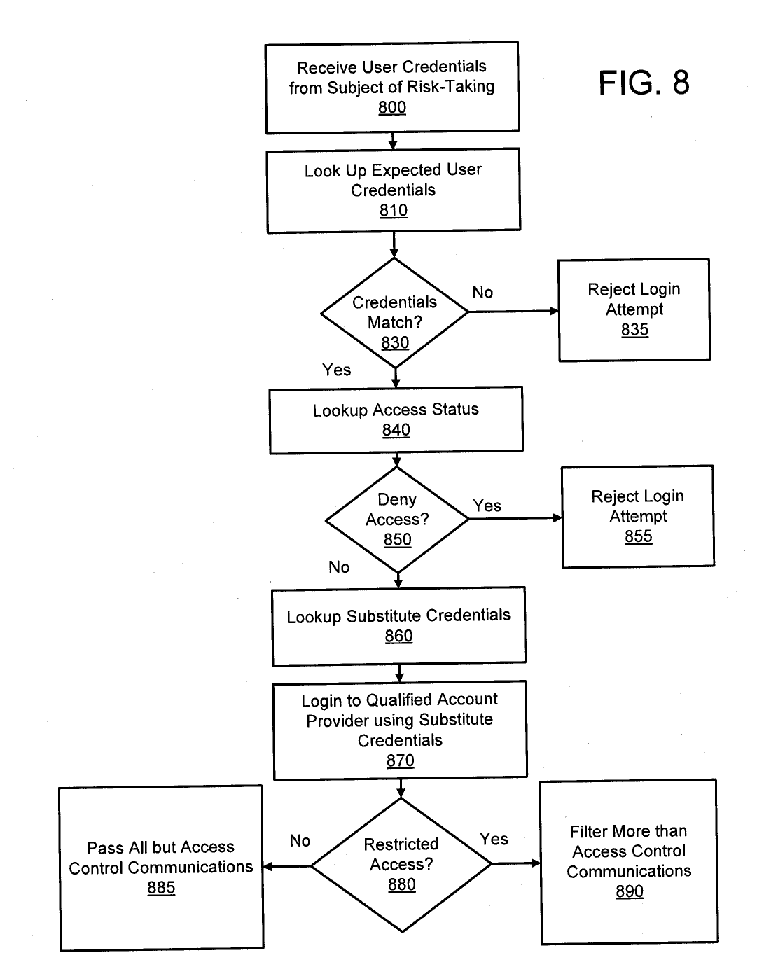

FIG. 8 shows an embodiment of a method to control access to the qualified account provider according to the inventive subject matter.

In step 800, the credentials are used to obtain access to one or more qualified accounts.

In step 810, the proxy server 220 looks up the expected credentials for qualified account.

In step 830, if the provided credentials match the expected credentials, step 840 is performed. Otherwise, step 835 is performed.

In step 835, the login attempt is rejected.

In step 840, the proxy server 220 looks up the access status for the qualified account in the local database 262. For example, the stability server 130 may have indicated that access to this qualified account should be denied because of late payments.

In step 850, if access status indicates access should be denied, step 855 is performed. Otherwise, step 860 is performed.

In step 855, the login attempt is rejected. In some embodiments, a message is provided to identify the reason for access denial—late payments for example.

In step 860, the proxy server 220 looks up substitute credentials in the database 262.

In step 870, the substitute credentials are used to login to the qualified account provider.

In step 880, if access is to be restricted based on the access status, step 890 is performed. Otherwise, step 885 is performed.

In step 885, all but access control communications are passed by the proxy server 220. The proxy server 220 passes communications back and forth between the subject of risk taking and the qualified account provider. When the proxy server recognizes certain requests as attempts to change the password or otherwise circumvent the control by the proxy server 220, the proxy server does not pass on those requests to the qualified account provider.

In step 890, more than access control communications are filtered by the proxy server 220. The proxy server 220 passes communications back and forth between the subject of risk taking and the qualified account provider. When the proxy server recognizes certain requests as attempts to change the password or otherwise circumvent the control by the proxy server 220, the proxy server 220 does not pass on those requests to the qualified account provider. When the proxy server 220 recognizes certain requests or responses that are forbidden according to the access status, the proxy server 220 does not pass on those requests to the qualified account provider. For example, the stability server 130 may have updated the access status to indicate that the subject of risk taking 100 cannot access their photos, or view certain message postings. In some embodiments, the proxy server 220 may filter out requests for those photos or particular message postings such that the qualified account provider never receives the requests and therefore never sends a response. In other embodiments, the proxy server 220 may filter out responses to requests for the photos or message postings such that the subject of risk-taking never sees those responses.

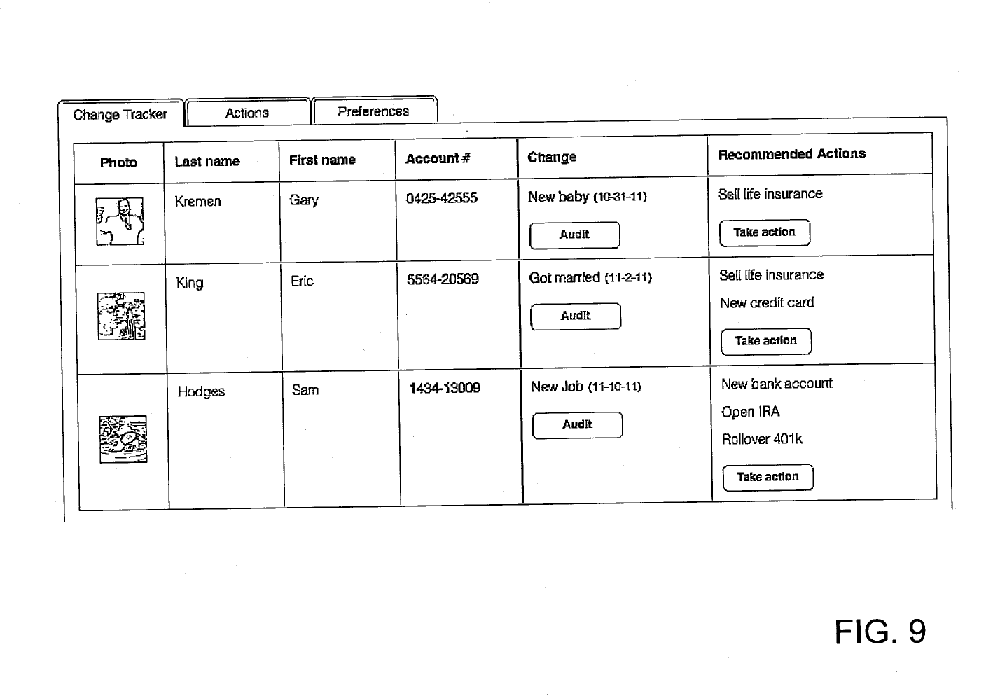

FIG. 9 is an illustration of one embodiment of a screen shot of a status report of the inventive subject matter.

The screen shot shows detected events (changes) for three independent subjects of risk-taking. The first has a new baby, the second has recently gotten married and the third has a new job. This screen might be presented at the computer of the risk-taking entity 100. The stability server 130 may provide several options for the risk-taking entity 100 based on the detected events. A lookup table may associate each detected or predicted event type with one or more recommended actions. For example, the stability server 130 may recommend selling life insurance to the subject of risk taking that just had a baby. The stability server 130 may recommend selling life insurance and offering a new credit card to the subject of risk taking that was recently married. The stability server 130 may recommend offering a new bank account and retirement savings accounts to the subject of risk taking that recently got a job. In some embodiments, these actions may be automatically taken by the stability server 130 by sending emails, for example, offering such services to the respective subjects of risk taking. In other embodiments, the recommended actions are presented to the risk taking entity 100 and the risk taking entity specifically approves the recommended actions by clicking an associated take action button on the screen.

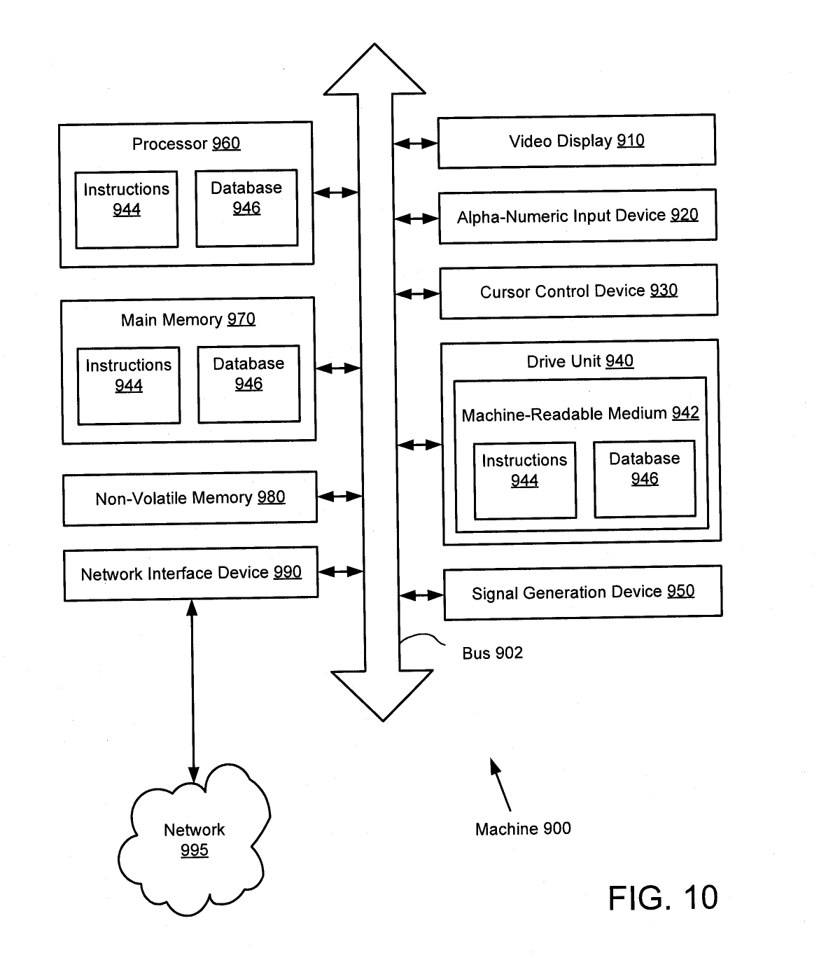

FIG. 10 is a diagrammatic representation of an embodiment of a machine 900, within which a set of instructions for causing the machine to perform one or more of the methodologies discussed herein may be executed. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with a server to facilitate operations of the server and/or to access the operations of the server. In some embodiments, the machine may act as a server for some functions and a client for other functions.

In some embodiments, the machine 900 is the stability server 130. In other embodiments, the machine 900 is a component of the stability server 130, such as one or more computers that make up the stability server 130. In other embodiments, the machine 900 is the proxy server 220 according to an embodiment as described herein. In one embodiment, the machine 900 is a computer operated at the risk-taking entity 120, the micro-lending market 170 or an entity acting on behalf of the risk-taking entity 120 or the micro-lending market 170.

The machine 900 includes a processor 960 (e.g., a central processing unit (CPU) a graphics processing unit (GPU) or both), a main memory 970 and a nonvolatile memory 980, which communicate with each other via a bus 902. In some embodiments, the machine 900 may be a cluster of computers or comprise multiple processors or multiple processor cores. In one embodiment, the machine 900 also includes a video display 910, an alphanumeric input device 920 (e.g., a keyboard), a cursor control device 930 (e.g., a mouse), a drive unit 940 (e.g., hard disk drive, Digital Versatile Disk (DVD) drive, or removable media drive), a signal generation device 950 (e.g., a speaker) and a network interface device 990.

In some embodiments, the video display 910 includes a touch-sensitive screen for user input. In some embodiments, the touch-sensitive screen is used instead of a keyboard and mouse. The drive unit 940 includes a machine-readable medium 942 on which is stored one or more sets of instructions 944 (e.g., software) embodying any one or more of the methods or functions of the inventive subject matter. The instructions 944 may also reside, completely or partially, on machine-readable media within the main memory 940 and within machine-readable media within the processor 960 during execution thereof by the computer system 900. The instructions 944 may also be transmitted or received over a network 995 via the network interface device 990. In some embodiments, the machine-readable medium 942 also includes a database 944 including some of the received information.

While the machine-readable medium 942 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methods or functions of the inventive subject matter. The term “machine-readable medium” shall accordingly be taken to include, but not be limited to, solid-state memories, optical and magnetic media, and other non-transitory tangible media.

In general, the methods executed to implement the embodiments of the disclosure, may be implemented as part of an operating system or a specific application, component, program, object, module or sequence of instructions referred to as “programs.” For example, one or more programs may be used to execute specific processes according to the inventive subject matter. The programs typically comprise one or more instructions set at various times in various memory and storage devices in the machine, and that, when read and executed by one or more processors, cause the machine to perform operations to execute methods, functions and other elements of the inventive subject matter.

Moreover, while embodiments have been described in the context of fully machines, those skilled in the art will appreciate that the various embodiments are capable of being distributed as a program product in a variety of forms, and that the disclosure applies equally regardless of the particular type of machine or computer-readable media used to actually effect the distribution. Examples of machine-readable media include, but are not limited to, recordable type media such as volatile and non-volatile memory devices, flash memory devices, floppy and other removable disks, hard disk drives, and optical disks such as Compact Disk Read-Only Memory (CD-ROMS) and Digital Versatile Disks (DVDs), among others.

Claims directed towards user event detection may include:

1. A computer-implemented method for verifying user compliance with a user representation with a computer system programmed to perform the method comprising: receiving with the computer system, a first plurality of social network data associated with a user and associated with a first social network, wherein the first plurality of social network data is associated with a first retrieval time; determining with the computer system, a second plurality of social network data associated with the user and associated with the first social network, wherein the second plurality of social network data is associated with a second retrieval time, wherein the first retrieval time is different from the second retrieval time; comparing with the computer system at least a portion of social network data from the first plurality of social network data to at least a portion of social network data from the second plurality of social network data to determine one or more differences, if any; determining with the computer system a stability indicator associated with the user in response to the one or more differences, if any; determining with the computer system whether the stability indicator exceeds a threshold stability indicator; and storing with the computer system an alert indicator when the stability indicator exceeds the threshold stability indicator.

2. The method of claim 1 further comprising sending with the computer system a communication to a recipient in response to the alert indicator; wherein the communication includes at least the portion of social network data from the first plurality of social network data and includes at least the portion of social network data from the second plurality of social network data; and wherein the recipient is selected from a group consisting of: the user, another user, a user associated with the computer system.

3. The method of claim 1 wherein the setting with the computer system the alert indicator further comprises: determining with the computer system a first parameter associated with a financial offering associated with the user; determining with the computer system a second parameter for the financial offering in response to the alert indicator; and indicating with the computer system to the user that the second parameter will be associated with the financial offering for the user.

4. The method of claim 3 wherein the first parameter is selected from a group consisting of: premium amount, rent, salary, payment terms, period of time, due date, discount, deductible, collateral release, collateral interest, security interest, security release, assignment.

5. The method of claim 4 wherein after indicating with the computer system to the user that the second parameter will be associated with the financial offering, the method further comprising: receiving an indication that the first parameter should remain associated with the financial offering associated with the user; and maintaining with the computer system the first parameter being associated with the financial offering associated with the user.

6. The method of claim 1 wherein the portion of social network data from the first plurality of social network data is selected from a group consisting of: e-mail messages, wall posts, instant messages, group affiliations, photograph-related data, geographical check-in information, tweets, images.

7. The method of claim 6 wherein photograph-related data is selected from a group consisting of: geographic location data, textual descriptions, tags, geographical locations photographically captured, actions photographically captured, users photographically captured, actions of the user photographically captured, users photographically captured with the user, images associated with smoking, images associated with alcoholic drinking, images of sky diving, images associated with scuba diving, images associated with rock climbing, images associated with motor sports, images associated with intoxication, images associated with gang affiliation, images associated with illegal activity.

8. The method of claim 6 wherein the portion of social network data from the second plurality of social network data comprises textual data selected from a group consisting of: smoking-related words, intoxication-related words, alcoholic drinking related words, sky diving-related words, scuba diving-related words, rock climbing-related words, motor sport-related words, death-related words, funeral-related words, divorce-related words, marriage separation-related words, medical therapy-related words, cancer-related words, HIV-related words, leave-related words, job status-related words, job termination-related words, job promotion-related words, baby-related words, motor vehicle-related terms, illegal activity-related words.

9. The method of claim 1 wherein the portion of social network data from the second plurality of social network data is selected from a group consisting of: a number of contacts associated with the user on the social network, a number of contacts associated with the user and associated with an employer of the user on the social network, a number of contacts associated with the user and not associated with an employer of the user on the social network.

10. The method of claim 1 wherein the portion of social network data from the second plurality of social network data is selected from a group consisting of: health-related condition of another user associated with the user, health-related condition of the user, health-related research associated with the user, a medical condition associated with the user not covered by medical insurance associated with the user.

11. The method of claim 1 wherein the portion of social network data from the second plurality of social network data is selected from a group consisting of: personal relationship status, marital status, extramarital affair indicators, messages communicated to non-spouses of the user, divorce-related status, sexual-behavior-related status.

Alternative claim language may include: Obtaining access to the social media account of the user, where obtaining access means being able to access life event data of the user associated with the social media account, where life data is such things as marital status, number of family members, location, education, interests; Look for changes in life event data; Upon a change detected, access a list of actions associated with each change in life event data; Perform such action(s) associated with each change in life event data.

Where changes life event data could indicate new baby and an associated action could be displaying to the user an offer for a 529 plan (dependent claim). Where changes life event data could indicate loss of a job and an associated action could be performing a credit line decrease for the user (dependent claim). Where access could be obtained by use of oAuth (dependent claim). Where the social media account could be FB, LI, TW, etc. (dependent claim).

Another implementation does not require life event change but just uses the life event data to perform the action of displaying a targeted advertisements using the FB Ad API or retargeting an appropriate advertisements. A software application displays to the user the FB oAuth window and obtains an access token after then user authenticates.

The software application periodically monitors the user FB account using the access token look to detect life events of the user such as new babies, job changes, health changes, relationship changes, moves, etc. Upon such changes being detected by the software application, the software applications perform such actions such as displaying financial nature advertising targeted based on the life event change such as a new baby might display a life insurance advertisement OR as lowering a line of credit of the user based on the life event of the user losing their job. A software application displays to the user the FB oAuth window and obtains an access token after then user authenticates.

The software application periodically monitors the user FB account using the access token look to detect life events of the user such as new babies, job changes, health changes, relationship changes, moves, etc. WHERE such detection is based upon social graph analysis OR semantic analysis. Semantic analysis could look for such things as the user having an affair.

In some embodiments, social graph analysis could be FB timeline feature.

Having described and illustrated the principles of the inventive subject matter with reference to the illustrated embodiments, it will be recognized that the illustrated embodiments may be modified in arrangement and details without departing from such principles. And, though the foregoing analysis has focused on particular embodiments, other configurations are contemplated. In particular, even though expressions such as “in one embodiment,” “in another embodiment,” and the like are used, these phrases are meant to generally reference embodiment possibilities, and they are not intended to limit the inventive subject matter to particular embodiment configurations. As used herein, these terms may reference the same or different embodiments that are combinable into other embodiments. Consequently, in view of the wide variety of permutations to the embodiments described herein, this detailed description is intended to be illustrative only, and it should not be taken as limiting the scope of the inventive subject matter.

Although specific embodiments have been illustrated and described herein, it will be appreciated by those of ordinary skill in the art that any arrangement or process that is calculated to achieve the same purpose may be substituted for the specific embodiments shown. This application is intended to cover any adaptions or variations of the inventive subject matter. Therefore, it is manifestly intended that embodiments of this inventive subject matter be limited only by the claims and the equivalents thereof.

What is claimed:

1. A computer-implemented method for managing the financial risk of a risk-taking scenario associated with a subject of risk-taking implemented on a computer system programmed to perform the method comprising:
receiving in the computer system, authorization to access a qualified account of a subject of risk-taking;
receiving in the computer system, data from the qualified account of the subject of risk-taking;
determining in the computer system, a stability score based on the received data, the stability score being an estimate of the financial risk in the risk-taking scenario; and
performing in the computer system, an action through the qualified account based on the stability score.

2. The computer-implemented method of claim 1 wherein the risk-taking scenario comprises at least one of lending money to the subject of risk-taking, purchasing equity in the subject of risk-taking, and insuring the subject of risk-taking.

3. The computer-implemented method of claim 1 wherein the qualified account is provided by one of a social network provider, an email service provider, a phone service provider, a messaging service provider, a gaming service provider, and an online forum provider.

4. The computer-implemented method of claim 1 wherein the received data comprises at least one of social network information, email messages, text messages, voicemail messages, online forum postings, contact database information, and gaming activities.

5. The computer-implemented method of claim 1 wherein the stability score is generated by applying to the received data at least one of linguistic analysis, sentiment analysis, quantitative analysis, event prediction analysis, and event detection analysis.

6. The computer-implemented method of claim 1 wherein the subject of risk-taking is an individual acting on their own behalf in the risk-taking scenario.

7. The computer-implemented method of claim 1 wherein the subject of risk-taking is an individual acting on behalf of a business entity in the risk-taking scenario.

8. The computer-implemented method of claim 1 wherein the action performed based on the stability score is one of approving a loan application submitted by the subject of risk-taking.

9. The computer-implemented method of claim 1 wherein the action performed based on the stability score is one of approving an insurance application submitted by the subject of risk-taking.

10. The computer-implemented method of claim 1 wherein the stability score is based on the detection or prediction of a relationship-related event for the subject of risk-taking, the relationship-related event comprising at least one of a marriage, civil union, domestic partnership agreement, common-law marriage, divorce, separation, and dissolution of a marriage, civil union, or domestic partnership agreement.

11. The computer-implemented method of claim 1 wherein the stability score is based on the detection or prediction of a health-related event comprising the diagnosis of a debilitating or fatal illness of the subject of risk-taking.

12. The computer-implemented method of claim 1 wherein the stability score is based on the detection or prediction of a legal event comprising at least one of a lawsuit filed against the subject of risk-taking, an arrest, and a conviction for a felony.

13. The computer-implemented method of claim 1 wherein the stability score is based on the detection or prediction of a financial event comprising at least one of a loan default, lien filing, and inheritance associated with the subject of risk-taking.

14. The computer-implemented method of claim 1 further comprising accessing an information provider based on a detected or predicted event.

15. The computer-implemented method of claim 15 wherein the information provider comprises one of a financial information provider, a legal information provider, a medical information provider, a news provider, a public records provider, a credit reporting agency and a crowdsourced-opinion provider.

16. The computer-implemented method of claim 15 further comprising the steps of:
receiving in the computer system, additional data from the qualified account of the subject of risk-taking, the additional received data being received a period after the received data.
determining in the computer system, an updated stability score based on the received data and the additional received data, the updated stability score being an updated estimate of the financial risk in the risk-taking scenario; and
performing in the computer system, an action through the qualified account based on the change from the stability score to the updated stability score.

17. The computer-implemented method of claim 15 wherein action is taken through the qualified account based on the stability score or a change in the stability score, the action taken comprises at least one of sending a private message to the subject of risk taking, posting a message viewable by at least one contact of the subject of risk-taking, limiting access to the qualified account by the subject of risk taking, denying access to the qualified account by the subject of risk taking, and restoring access to the qualified account by the subject of risk taking.

18. A computer-implemented method for verifying user compliance with a user representation with a computer system programmed to perform the method comprising:
receiving with the computer system, a first plurality of social network data associated with a user and associated with a first social network, wherein the first plurality of social network data is associated with a first retrieval time;
determining with the computer system, a second plurality of social network data associated with the user and associated with the first social network, wherein the second plurality of social network data is associated with a second retrieval time, wherein the first retrieval time is different from the second retrieval time;
comparing with the computer system at least a portion of social network data from the first plurality of social network data to at least a portion of social network data from the second plurality of social network data to determine one or more differences, if any;
determining with the computer system a stability indicator associated with the user in response to the one or more differences, if any;
determining with the computer system whether the stability indicator exceeds a threshold stability indicator; and
storing with the computer system an alert indicator when the stability indicator exceeds the threshold stability indicator.

19. The method of claim 18 further comprising sending with the computer system a communication to a recipient in response to the alert indicator;
wherein the communication includes at least the portion of social network data from the first plurality of social network data and includes at least the portion of social network data from the second plurality of social network data; and
wherein the recipient is selected from a group consisting of: the user, another user, a user associated with the computer system.

20. The method of claim 18
wherein the setting with the computer system the alert indicator further comprises:
determining with the computer system a first parameter associated with a financial offering associated with the user;
determining with the computer system a second parameter for the financial offering in response to the alert indicator; and
indicating with the computer system to the user that the second parameter will be associated with the financial offering for the user.
